(19) United States
(12) Patent Application Publication
(10) Pub. No.: US 2005/0020945 A1
(43) Pub. Date: Jan. 27, 2005

(54) Acoustically-aided cerebrospinal-fluid manipulation for neurodegenerative disease therapy

(76) Inventors: Carol A. Tosaya, Los Altos, CA (US); John W. Sliwa JR., Los Altos, CA (US)

Correspondence Address: David W. Collins;Intellectual Property Law, Suite 125B, 75 Calle de las Tiendas, Green Valley, AZ, 85614, US

(21) Appl. No.: 10/767,752

(22) Filed: Jan. 29, 2004

Related U.S. Application Data
(63) Continuation-in-part of application No. 10/612,171, filed on Jul. 1, 2003.
(60) Provisional application No. 60/443,413, filed on Jan. 29, 2003.
(60) Provisional application No. 60/394,089, filed on Jul. 2, 2002.

(51) Int. Cl. A61H 1/00

(52) U.S. Cl. 601/2

(57) ABSTRACT

An apparatus and method provide therapy to a patient having, or who may potentially develop, a neurodegenerative disease characterized by abnormal proteins or prions or related deposits. The apparatus includes an emitter means to deliver acoustic, ultrasonic or vibratory energy in, into or from within a region of the patient's brain or spine which contains or is transportably-coupled to cerebrospinal fluid (CSF) or blood capable of bearing or bearing a chemical or biological species, reactant, fragment or byproduct of the disease.

### CROSS-REFERENCE TO RELATED APPLICATIONS

The present application claims priority from provisional application Ser. No. 60/443,413, filed Jan. 29, 2003. The present application is also a continuation-in-part of application Ser. No. 10/612,171, filed Jul. 1, 2003, entitled “System And Methods For Treatment Of Alzheimer's And Other Deposition-Related Disorders Of The Brain”, filed in the names of the present Applicants (“prior application”). That application claims priority based on provisional application Ser. No. 60/394,089, filed Jul. 2, 2002.

In the parent application, Applicants teach the use of vibrational excitations, preferably acoustic or ultrasound waves, delivered into one or more human brain regions, to achieve one or more of three neurodegenerative-therapy processes. These processes are summarized therefrom as follows: (1) breakup, breakdown, transport, removal or redistribution of undesired abnormal protein or prion deposits, nodules or bodies or intermediates thereof, (2) interference in at least one physical, chemical, biological or genetic process or pathway which is causing or ultimately may cause or allow an abnormal protein or prion deposit, nodule or body to form, and (3) aiding the recovery, growth, regrowth, perfusion or improved chemical, physical, biological, genetic or cognitive functionality of brain-related cells, physiology or functional pathways negatively impacted or stressed by the deposition of, formation of, or presence of such deposits, nodules or bodies or their associated formation processes.

Applicants further teach that the targets of the therapy, the undesired deposits or their associated intermediate products or species which encourage or enable the formation thereof, can be reduced in concentration with time in order to at least slow if not stop or reverse the neurodegenerative processes taking place or anticipated to take place. Also taught are various ways of aiding recovery processes such as enhancing perfusion or cognitive function in other brain tissues not necessarily yet directly invaded by such deposits or processes. Also taught is the optional use of various drugs or medicaments in support of one or more of the inventive therapy processes. The invention herein utilizes at least the ultrasound therapy aspect of the pending patent, and may also, if desired, use a drug.

### FIELD OF THE INVENTION

The present invention is directed to acoustically, ultrasonically or vibrationally-aided therapies for patients with, or with potential for developing, neurologically degenerative diseases.

### BACKGROUND ART

Recently, it has come to our attention that a cerebrospinal-fluid (CSF) shunt device is being used to experimentally treat Alzheimer's disease. In effect, the shunt is a spinal-fluid drain originally used mainly for hydrocephalus patients to relieve spinal fluid (CSF) overpressure or flow-blockage. It was accidentally discovered by prior investigators that patients with Alzheimer's who received the hydrocephalus shunt-treatment not only had their hydrocephalus treated successfully but, inadvertently, their Alzheimer's symptoms were simultaneously improved. It has since been deduced by several researchers that by artificially shunt-draining some cerebrospinal fluid (CSF) that the concentration of at least one chemical or biological species responsible for enabling or encouraging Alzheimer's degradation processes is thus beneficially reduced by such use of a drainage shunt. Clearly, this seems to be the case based on clinical data to date.

It is known that drained CSF is found to contain multiple constituents associated with Alzheimer's processes and by-products. It is specifically thought that at least the Alzheimer's Tau-Protein concentration found in CSF is beneficially reduced by such shunt drainage. In essence, an undesirable concentration of species, Tau in the Alzheimer's case, is removed in the drained fluid, and new freshly made fluid replaces it. Thus, the net concentration of Tau in CSF is diluted or reduced. Thus, the reduced concentration of Tau in the CSF assures both that it is a more willing sink for Tau exiting the brain and that the CSF itself is less able to act as a source of Tau moving into the brain. It is currently thought that the former is the primary mechanism, namely, Tau entering the CSF from the brain where it is produced; however, our invention herein covers both possibilities.

We soon recognized that our ultrasound-driven or ultrasound-enabled approach and the shunt approach can benefit each other. The shunt acts as a sink for concentrations of undesired species that contribute or enable the Alzheimer's degradation processes. The CSF, which resides in the ventricles and other anatomically known brain and spinal cavities, is thought to slowly pick up these species from the brain by natural diffusion, perfusion and other ongoing bodily biochemical and transport processes. We have described in great detail in our prior application (Ser. No. 10/612,171) how ultrasound can alone or in combination with drugs, vitamins, minerals and even controlled diets can greatly increase the rate of transport, redistribution, removal or breakdown of undesired abnormal protein species or byproducts. We herein describe the use of our previously disclosed ultrasound processes in combination with the use of such a shunt, wherein the shunt acts as a sink of Alzheimer's products or intermediates (e.g., Tau-Protein) and the ultrasound enhances or accelerates the movement of such undesired, putative or toxic products into the CSF for shunt-removal. The use of a drug, as taught in the prior application, is also an option for this ultrasound-shunt combination.

We realized that our ultrasound processes can contribute to the accelerated breakup, transport, or redistribution of abnormal-protein products or intermediate reactants such that the natural flow (or enhanced flow via shunting) of CSF can remove a greater amount of them per unit time or a greater amount of them over a given time. In essence, our ultrasound exposure effectively increases the mobility and/or diffusion of such undesired species within brain portions toward the ventricles in which flushing CSF passes. Our ultrasound processes can also contribute to the breakup or breakdown of abnormal protein intermediate species or deposits such that there is a higher mobile concentration of them available for removal. So in summary, we can, with ultrasound, accelerate the breakdown and/or macroscopic and microscopic motion of undesired species or related intermediates toward the ventricles or other CSF sinks or cavities. Since the CSF is flowing, albeit at a slow rate, the concentrations of such species in the CSF are lower than in the diseased brain; thus, natural diffusion can also drive the transport of such species from brain tissues into CSF-filled ventricles or brain cavities. Another way to look at it is that the shunt is a sink and the ultrasound processes are greatly enhancing the existing source's ability to release or diffuse undesirable species, their constituents, or their precursors into the adjacent sink.

We will refer to the following references:
(1)“Draining Alzheimer's Disease”, Ivanhoe News Wire, California Nov. 25, 2002;
(2) “New Technique Could Help Patients With Alzheimer's”, Health Newswire, London, Oct. 23, 2002;
(3) U.S. Pat. No. 5,980,480 to Rubenstein et al;
(4) U.S. Pat. No. 6,264,625 to Rubenstein et al;
(5) U.S. Pat. No. 6,383,159 to Saul et al; and
(6) Eunoe Corp. Web Site, www.eunoe-inc.com.

The article entitled “Draining Alzheimer's Disease” describes, from a layman's point of view, the use of a shunt to drain cerebrospinal fluid (CSF) from the brain into the abdomen. The major constituent of CSF is water but that water incorporates innumerable natural beneficial (and sometimes not) biological species in it and, for a patient with Alzheimer's, this includes undesired abnormal species or abnormal quantities of species associated with that disease. Such abnormal Alzheimer's species concentrations could include, for example, Amyloid-Beta proteins and, especially, Tau proteins.

After shunt-drainage was found to work in mice, the researchers demonstrated the cognitive degradation-slowing benefits in 29 or so humans split evenly into control and test subgroups. Recent clinical work has shown that Alzheimer's patients have significantly more stagnation in their spinal fluid flow than normal older persons whose flow is already slowed or stagnated relative to younger persons. Alzheimer's patients, in particular, appear to have the resorptive paths for their CSF diminished. Thus, the shunt effectively increases the CSF flow by “contaminated” CSF removal and replacement of the removed CSF fluid by newly formed “uncontaminated” CSF fluid. The increased flow of fresh CSF removes more Alzheimer's species from the brain, since the brain is in diffusive and perfusive communication with the CSF cavities such as the ventricles in the brain. The concentration gradient of such species, which is increased by the improved CSF flow, further drives the transport of such undesired species faster from the brain into the CSF cavities or into other CSF lumens.

The first article concludes with describing a currently approved larger study involving 256 patients spread across 25 or so clinical centers. That study is underway now. It should be kept in mind by the reader that, historically, shunts have been used for Hydrocephalus Therapy wherein CSF flow is either excessive or is blocked internal to the brain. In the Alzheimer's application, there is not necessarily any such excessive flow or blockage; in fact, there is usually less flow and no significant blockage in the ventricle structures, but the natural resorptive paths for CSF, such as resorption into the bloodstream, may be diminished as stated. Alzheimer's patients may also have very low CSF production rates as mentioned.

The article “New Technique Could Help Patients With Alzheimer's” describes the clinical results of the above first 29 patients in somewhat more detail. Noted is the fact that there were some shunt complications (infection, etc.) in some of the patients but that these complications were not of a neurological nature and that they occur in Hydrocephalus patients. That is obviously not to say that it would not be good to overcome such complications but it is to say that the benefits to Alzheimer's seem solidly demonstrated.

U.S. Pat. No. 5,980,480 to Rubenstein et al and assigned to CS Fluids Inc., entitled “Method And Apparatus For Treating Adult-Onset Dementia Of The Alzheimer's Type”, will be discussed next. This patent covers the method of removing at least some CSF from inside the arachnoid membrane and transporting it to another body sink such as an abdominal cavity for purposes of Alzheimer's therapy. It also covers the case wherein some of the CSF is also recirculated to the ventricles by pump with or without filtering. The great majority of teaching addresses the detailed plumbing in terms of the implanted catheter and valves, the details of which are not critical to our invention herein. What we wish the reader to note is the claimed method mentioned above and taught therein as well as Rubenstein's mention of the prior art U.S. Pat. No. 5,334,315 to Matkovich, which involves the removal, treatment and recirculation of bodily fluids for cleaning or detoxifying purposes. Also of relevance herein is Rubenstein's description, long known to the art, of how CSF is normally transported from within the arachnoid space into the blood through the arachnoid villi located just inside the skull and distributed over the superior surfaces of the cerebral hemispheres. All of Rubenstein's embodiments and teaching involve at least some CSF being removed from the body permanently and his taught reduction in undesirable CSF-resident species is taught to take place because of the removal itself, i.e., via dilution as is logical and expected of his method.

U.S. Pat. No. 6,264,625, also to Rubenstein and assigned to CS Fluids Inc., also entitled “Method And Apparatus For Treating Adult-Onset Dementia Of The Alzheimer's Type”, gives further plumbing and pumping details and has claims primarily directed toward the apparatus of the above '480 patent. Note that the apparatus claims appear to be non-Alzheimer's specific. Rubenstein also teaches therein that a desirable CSF removal rate is 10 to 20% of the bodily CSF replacement rate. A description of the required implantation surgery is also provided.

U.S. Pat. No. 6,383,159 to Saul et al and assigned to Eunoe Inc. (formerly CS Fluids Inc.), entitled “Devices And Methods For Removing Cerebrospinal Fluids From A Patient's CSF Space”, essentially offers an improved fluid removal scheme in terms of how CSF pressure is controlled in relation to CSF flow. A slow steady rate of CSF is removed at relatively constant pressure. The patent discloses a method including identifying a CSF toxic problem and then doing the CSF drainage per the teaching. It essentially represents a (proposed) safer pressure/flow regimen than the above patents teach for application to Alzheimer's patients. A specific diaphragm valve design is taught.

Finally, for completeness, we include a citation to the Eunoe Inc. website, which is really written for prospective patients and investors. It superficially describes the details already described at length in the above references.

We stress that our definition of “shunt” for the purpose of the present application includes any device or apparatus which at least one of (a) removes from a brain region at least some CSF or CSF constituent permanently or temporarily, or (b) removes from a brain region at least some CSF or CSF constituent for treatment and readmission to a patient, or (c) performs in-situ treatment of at least some CSF or CSF constituent wherein “in-situ” means the “shunt” is at least partially in, on or at least temporarily attached-to, mounted-upon or connected-to the patient, or (d) at least temporarily reroutes or redirects at least some CSF or CSF constituent. We believe that these prior art “shunting” devices are known from the above cited art. So, in essence, we broadly define “shunt” to be any present or future device which, at least temporarily, transports, redirects, controls or processes at least some CSF or CSF constituent for at least one of drainage, CSF or CSF constituent flow, pressure or concentration control, flow redirection, “cleanup” or “detoxification” purposes. By treatment or processing of CSF we also include, per the cited art, dialysis methods, whether performed external or internal to the body.

### SUMMARY OF THE INVENTION

In accordance with the present invention, an apparatus and method are disclosed and claimed for providing therapy to a patient having, or who may potentially develop, a neurodegenerative disease characterized by abnormal proteins or prions and related deposits comprising:
emitter means to deliver acoustic, ultrasonic or vibratory energy in, into, toward or coupled into a region of the patient's brain or spine which contains or is in transportable communication with cerebrospinal fluid (CSF) capable of bearing or bearing a chemical or biological species, reactant, fragment or byproduct of the disease;
the emitter operable to at least one of: (1) enhance, promote, or enable, directly or indirectly, the formation and/or transport of the species, reactant, fragment or byproduct which is transportable out of a brain or spine region and into a CSF space or into the bloodstream, (2) enhance or promote the increased production of fresh CSF, and (3) enhance or promote the increased production of fresh CSF or blood;
the enhanced formation, transport and/or production contributing to at least some removal of the species from the body and/or at least some immediate or anticipated reduction in concentration of the species in a portion of the body at least in part by using one or more natural paths, emitter-enhanced paths, drug-enhanced paths, surgical or artificial shunting means, or external dialysis or filtering means, thereby at least slowing or stopping a disease process; and
the patient optionally receiving a drug before, during or after an operation of the emitter(s) to at least one of: (1) act or help act against a disease process or a contributing factor thereto, (2) promote the formation or transport of a species that is to be removed or is more easily removable than a natural species, (3) encourage or enable growth or regrowth of new or transplanted brain or stem cells or enhance functional brain or neural pathways, (4) encourage or enable the beneficial uptake, processing or interaction of a genetic medicament, and (5) minimize potential or expected side-effects of an emitter exposure or shunting procedure.

We emphasize that the desired decrease in concentration or removal of a species may be immediate or may occur with some time-delay as formation (if any), transport and flow processes take place in the brain and body, so by decrease we mean an ultimate decrease which may even be preceded by a near-term increase as such newly-formed or newly-mobilized species are released in large amounts with initial emitter exposures. In any event, the apparatus and method of the present invention will reduce, over time, a concentration of a species in a brain or spine region, the targeted species in that region therefore less able to support the undesirable progression of the disease in a brain or spine.

It should be clear now that the present invention may use ultrasound in one or more of several ways to provide therapy such as: (a) to help form more of a removable or mobile species, (b) to help transport a species to be removed or mobilized across or through tissues, CSF or blood, (c) to favorably increase the transport or mobility of a species across membranes or interfaces, such as a CSF/brain, CSF/blood or brain/blood interface, blood-brain-barrier, arachnoid membrane or arachnoid-villi, (d) to promote the formation of new CSF, and (e) in a special case, to promote the tying-up or deactivation of species in-situ wherein transport to CSF and/or blood is then optional depending on the toxicity of the tied-up products.

### BRIEF DESCRIPTION OF THE DRAWINGS

FIG. 1 is a schematic representation of the human body including the brain and spinal cord. Blood and cerebrospinal fluid (CSF) flows are shown therein as are indicators of the intake and excretion of food and wastes. Also shown are an acoustic therapy transducer and an optional means of delivering a drug with sensor feedback.

FIG. 2 is a graph of the concentration of undesired species in the CSF vs. time as the therapy of the invention is applied, indicating a rise in concentration of the undesired species in the CSF due to the therapy, the temporary rise causing an enhanced depletion of the species from the brain matter.

FIG. 3 is a diagram of the patient's head showing a number of features including two therapy transducers, a shunt which taps a CSF-containing ventricle, and two such ventricles. Acoustic radiation is shown impinging into portions of the skull, the ventricles and the CSF therein. CSF is shown flowing out of the shunt.

### DETAILED DESCRIPTION OF THE PREFERRED EMBODIMENTS

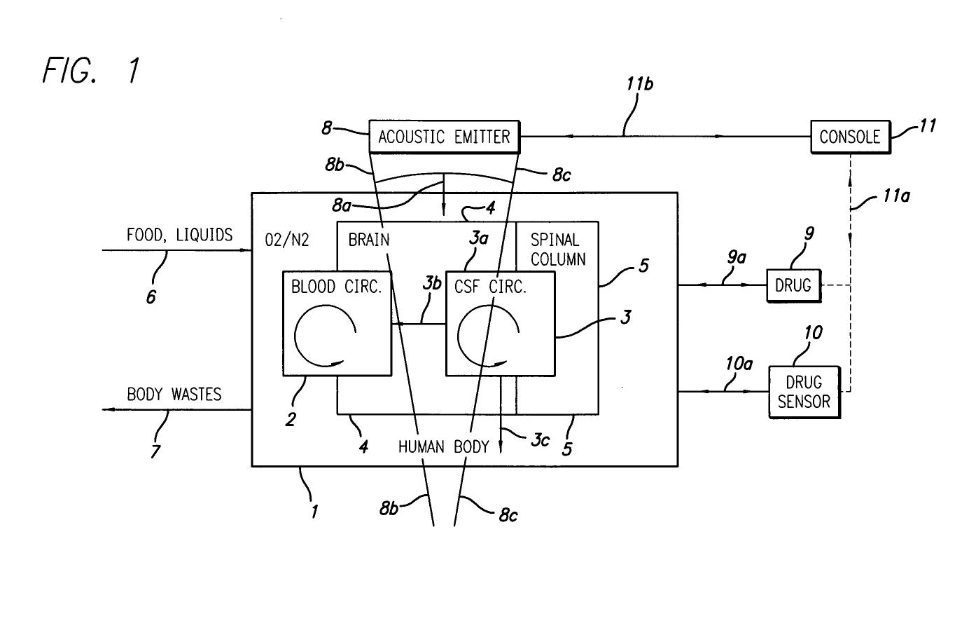

Beginning with FIG. 1, there is shown schematically a human body, denoted by the box labeled as 1. Within the human body 1 are the brain 4 and the attached spinal column 5; thus, items 4 and 5 are shown juxtaposed. The bodily blood circulation paths are represented by element 2 and more specifically by blood flow 2a therein. Since blood in the human body circulates in the brain as well as in the rest of the body, element 2 is shown as being both in the brain and in the rest of the body.

The body also produces and circulates CSF or cerebrospinal fluid and these CSF paths are indicated as element 3, with the actual flow of CSF indicated by arrow 3a. It will be appreciated that, since there is CSF in both the brain and the spinal column, CSF 3 and CSF flow 3a are shown taking place in both the brain 4 and spinal column 5. CSF item 3 is normally passed into or resorbed into the bloodstream 2 as indicated by arrow 3b. Arrow 3c represents an artificially arranged flow of CSF out of the brain and/or spinal column as is surgically done using a shunt. Thus, arrow 3c should be thought of as a shunt that removes CSF 3 from its normal bodily conduit(s) and dumps it or places it elsewhere. Elsewhere would typically be in the peritoneal space in the abdomen via flow through an implanted catheter as discussed in the prior art. Elsewhere could also include flow into a waste tank or bag which is discarded by the patient. The important element here is that some CSF is removed artificially; at least temporarily if not permanently, the details of the known and preferred valves and plumbing are less important to the invention herein. The above references describe such plumbing arrangements.

We indicate bodily intake of food, liquids, and O₂-N₂ (air) as arrow 6. Also indicated are normal bodily waste excretions 7 which include human wastes, urine, and exhaled air and perspiration. A therapy acoustic emitter 8 of the present invention directs acoustic energy 8a into the body 1. In particular, acoustic energy 8a is shown as being delivered with a weakly shaped beam defined by 8b and 8c and directed toward the previously described blood flow path 2a and/or CSF flow path 3a in the brain and/or spinal column. A therapy console or control box 11 is shown connected to the acoustic emitter 8 by cable(s) 11b. Also shown are a drug dispenser 9 and a drug-related sensor 10 connected into the body via, for example, lumen 9a and cable 10a, respectively. The console 11 is optionally shown communicating with the dispenser 9 and sensor 10 via a cable 11a.

We emphasize that the drug and associated sensor are optional. Types of drugs for treatment of neurodegenerative diseases are described in great detail in the prior application (Ser. No. 10/612,171). The sensor, also discussed in the prior application, may, for example, consist of a real-time blood test or CSF test that reports a parameter used to make decisions regarding administration of the therapy-related drug(s) and/or operation of the emitter(s). If sensor 10 were being used for emitter-operative control we would relabel element 10 as a “therapy feedback” sensor. So sensor 10 may monitor a drug parameter (shown) and/or may monitor a CSF or blood species useful in providing feedback for operation of the emitter(s) (not shown).

Thus, as shown in FIG. 1, we have an acoustic therapy system working in concert with a CSF shunt 3c and we also have the use of an optional drug. The flow (and/or pressure) of CSF in the shunt may also optionally be monitored and/or controlled by the inventive system. This is a new aspect for the shunt art.

Let us now discuss some mechanisms by which the acoustic, ultrasonic or vibratory inventive excitations of the type 8a can accelerate, enhance or enable the passage of undesirable species from the brain/column into the CSF for subsequent drainage by shunt 3c (or can improve resorption of CSF into the bloodstream). Such undesirable species associated with Alzheimer's could include Tau proteins, for example. These mechanisms include, but are not limited, to:
(1) Accelerated diffusional, perfusive or other mass-transport of species across a brain/CSF interface, membrane or barrier, for example, movement of Tau from brain matter into CSF residing in an adjacent ventricle.
(2) Accelerated diffusional, perfusive or mass-transport of species or of CSF or of any CSF-contained species across the arachnoid villi, across the blood-brain-barrier, or across an arachnoid space boundary and into the bloodstream. For example, acoustic illumination increases the permeation of the arachnoid villi to outgoing species-laden CSF passing into the bloodstream.
(3) Acoustically driven stirring, streaming, perfusion or flow of blood in a blood flowpath/lumen or of CSF in a CSF cavity or lumen, the enhanced or initiated flow contributing to mass transport of a species in a direction useful for its natural or artificial removal from the body.

The first thing to notice is that our invention can be used with or without a shunt. This is because mechanisms (1)-(3) can both increase the passage of species into CSF and/or can increase the passage of species-laden CSF into the blood-stream.

For example, mechanism (1) increases species concentration in ventricle CSF. The CSF could be partially shunt-drained and/or could be naturally dumped into the bloodstream (possibly with the help of acoustics further opening the arachnoid villi or BBB). In any event, a higher concentration of species is made available for removal.

Mechanism (2) focuses on increasing the flow of species-laden CSF into the bloodstream in the scalp region, but some deeper-penetrating acoustic energy may also accelerate the transfer of species from brain material into a CSF cavity.

Mechanism (3) addresses enhancement or initiation of macroscopic diffusive, perfusive, and stirring phenomenon, which can work over macroscopic distances of millimeters to tens of centimeters, thus favorably manipulating species transport to or within CSF-filled ventricles or to or within blood-filled passages.

As we have discussed, there is also the mechanism of acoustically-enhanced production of the species that may work with one or more of the above mechanisms, or may work using only the natural transport processes.

In discussing these three mechanisms, it should be kept in mind that if one is only using the prior art shunt, as taught in the shunt references to treat Alzheimer's, then what controls how much and how fast the undesired species in the CSF can be removed from brain/cord into the shunted CSF cavity(ies) and out of the body is (a) the diffusion/perfusion or mass-transport rates of such species across the brain and then across the brain/CSF interface into the CSF and then (b) the flushing (flow) rate of the CSF provided by the shunting arrangement and any natural (CSF) liquid-phase mixing that may or may not take place.

Once the shunting begins, the concentration of the undesired species in the CSF soon drops (due to dilution of freshly made CSF). This is good in that abnormally high concentrations of species are removed with the removed CSF; however, the bad news is that it can then become the ability of the species to transport itself to the CSF cavities across the brain and across the brain/ventricle interface that becomes rate limiting. In this manner, the shunt-only approach has diminishing returns as the flow rate is increased, and in fact, the rate cannot be increased without endangering the patient for reasons given in the shunt references. This is not to say shunt-only therapy is not worthwhile; rather, it is to say that one can do even better. By better we mean that with the use of the invention herein, using acoustic exposure (s), we can remove the undesired species faster and/or more completely (by using acoustic formation and/or transport enhancements) in a given amount of time and at a desirable and safe slow CSF drainage rate. We can even provide useful species reduction without use of a shunt at all.

Generally, the invention herein performs a faster or more thorough reduction of undesired species using a combination of the ultrasound exposure(s) and a shunting arrangement. In a special embodiment of the invention, we go so far as to eliminate shunting entirely and use the ultrasound to effectively cause existing undesired species to pass into one or both of CSF cavities and/or the bloodstream faster for given fixed blood flow and CSF flowrates whatever they happen to be. The reader should note that the prior shunt art does not address accelerating the diffusion of CSF into blood. We can even further enhance the situation by further opening-up the arachnoid villi and/or BBB using the acoustic energy.

Beginning with mechanism (1) above, that of moving CSF species across the boundary between the brain 4 and the CSF cavity 3 and into CSF circulation 3a of FIG. 1, we note that it is known that the diffusion or mass-transport of species across tissue membranes or cell membranes can be acoustically accelerated. For example, the acoustic “opening” of the blood-brain-barrier (BBB) to inward progressing drugs is discussed in the prior application (Ser. No. 10/612,171). However, to our knowledge, we are the first to utilize ultrasound to increase the diffusivity or permeation rate of the tissue/liquid interface at the brain/CSF cavity interfaces(s). Such interfaces define the surfaces of the known CSF cavities such as the ventricles and related connected CSF conduits. To our knowledge, we are also the first to describe enhanced outward transport of CSF or CSF species from the brain, arachnoid membrane or arachnoid villi and into the bloodstream under the scalp, for example.

We have taught in the prior application (Ser. No. 10/612,171) various acoustic and acoustic/drug processes that can accelerate or enable the reduction or removal of neurodegenerative deposits or the interference in the formation of their intermediate by-products. What we add here in the present invention is that the ultrasound herein can also serve to “open” or increase the permeability of the brain/CSF cavity interfaces such that species can be more quickly extracted into the CSF across that boundary. Such “opening” may be by transitory increases in permeation rates caused by ultrasound or may be due to the acoustic streaming pressures or flows created across such interfaces under real-time acoustic illumination. Such “opening” may also simply comprise imposing a higher concentration of species across the brain/ventricle boundary so diffusion is increased without acoustic alteration of the boundary itself. Both effects may be present.

It is also important here to indicate that the ultrasound exposure may be coming from one or more directions from outside or inside the skull, as in the prior application (Ser. No. 10/612,171). For example, an ultrasonic emitter could be placed inside a ventricle via a lumen such as is provided for a shunt. In the case of the use of an optional drug, as taught in the prior application, we expressly include the variation wherein the drug is administered into the CSF cavities and the afore-mentioned acoustic exposure enhances the transport of the drug into the brain from the CSF cavities.

Moving now to mechanism (2), we note again arrow 3b of FIG. 1, which indicates the natural flow of CSF from the CSF cavities such as the ventricles 3 ultimately into the bloodstream 2 under the scalp via the arachnoid villi. We note that ultrasound radiation 8 illuminates the arachnoid villi under the scalp so that the diffusion, flow or mass-transport of CSF and any species contained therein through the villi will be accelerated. Such acceleration is by, for example, inwardly directed acoustic radiation 8a, further opening the arachnoid villi for a transitory period after the acoustics are turned off or turned down.

If the acoustics are inwardly directed as are those of 8a, then it is probably best to perform an acoustic exposure, open up the villi, and turn the acoustics off to prevent acoustic streaming from preventing outward flow through the villi. Thus, this is similar, but unique from, acoustic opening of the BBB because the species of interest herein is traveling outwardly (rather than inwardly as for a drug), the species is the CSF and its contained neurodegenerative products (not a drug necessarily), and we are accelerating a natural arachnoid-villi transport process (not blasting open a normally closed BBB). The invention however also provides the option of opening the BBB for passage of CSF or its constituents.

It will also be recalled from the above discussions that Alzheimer's patients frequently have reduced CSF resorptive or removal rates, with most such removal normally occurring through the arachnoid villi into the scalp region blood-stream. Thus, we can benefit the patient in two unique ways here: (a) accelerate movement of species into the CSF cavities for shunting (or natural) removal and/or (b) accelerate movement of species in CSF across the arachnoid villi into the blood-steam. Note again that (a) will benefit from a shunt, but even without a shunt we will be increasing the concentration of such species in CSF for natural removal. Secondly, (b) does not require a shunt, as CSF species are dumped into the bloodstream; however, if the acoustic exposure is exposing both the arachnoid villi and the CSF cavities, then the shunt will benefit removal of what species make it to the CSF cavities while the ultrasound will also accelerate the removal of CSF species exiting the arachnoid villi. Included in the scope of the present invention is the use of any means, via acoustics, drugs or otherwise, to increase blood flow rates in the vicinity of the arachnoid villi if that further enhances species removal rates from the villi. This is analogous but different from CSF shunting in that we increase flow of a sink fluid (blood) for species to be eliminated from the body.

Moving now to mechanism (3), we utilize the acoustic streaming pressure of the ultrasound to enhance mass-transport of CSF and/or of blood, which is carrying the species of interest. Thus, we might stir or mix CSF within the ventricles or we may enhance blood perfusion within the brain. The acoustic illumination may also enhance permeability and diffusion of cells, membranes and lumens across which the species needs to be transported (or extracted from) for exit to CSF or blood. Such streaming and permeation may occur throughout the brain and ventricles for deeply-penetrating ultrasound.

It will be appreciated by those skilled in this art that any of the above mechanisms may be combined with the previous invention disclosed and claimed in the prior application (Ser. No. 10/612,171), wherein a drug's effect is preferably enhanced with ultrasound. Such a drug, a Tau antibody for example, could help stop Tau formation and make inactivated Tau materials available as the species to be removed. A combination approach wherein a drug is directed to a disease process or depositional material (as previously taught) and the herein taught acoustically-enhanced transport steps are also introduced, with or without the use of a shunt, offer numerous parallel paths for reducing species concentrations.

It will be appreciated by those skilled in this art that the shunt references cited herein teach “shunting” to typically consist of the permanent removal of some amount of CSF fluid. However, they also teach non-productized approaches wherein the CSF is only temporarily removed so it can be artificially processed (such as by dialysis) for species-removal and is then readmitted to the body or at least re-admitted to the CSF cavities in a “cleaned-up” state. We expressly include within the scope of the invention “shunting” to comprise any means to extract undesired species from the CSF or from the blood wherein the process includes (a) artificially arranged dumping of CSF or blood containing an undesired species to a region away from the brain, or (b) diversion of the flow of CSF or blood containing an undesired species and processing of the diverted fluid to remove at least some species, and then the “cleaned-up” fluid is readmitted to the CSF cavities or to the bloodstream.

It should now also be clear that one may arrange for acoustic illumination to impact one or both of a CSF/brain tissue interface (at a ventricle wall), a CSF/spinal column interface or a CSF/blood interface (such as the arachnoid villi). In this manner, undesired neurodegenerative-associated species can be removed inwardly and outwardly at the same time if desired. One skilled in the art will be aware that via frequency-selection, one may control the depth of penetration of ultrasound into the brain. So, for example, one could acoustically expose the arachnoid villi under the scalp without exposing large amounts of brain matter using high-frequency ultrasound, preferably in combination with the cooling means taught in the prior filing. The cooling means can assure that the lossy skull bone does not get too hot at such high frequencies.

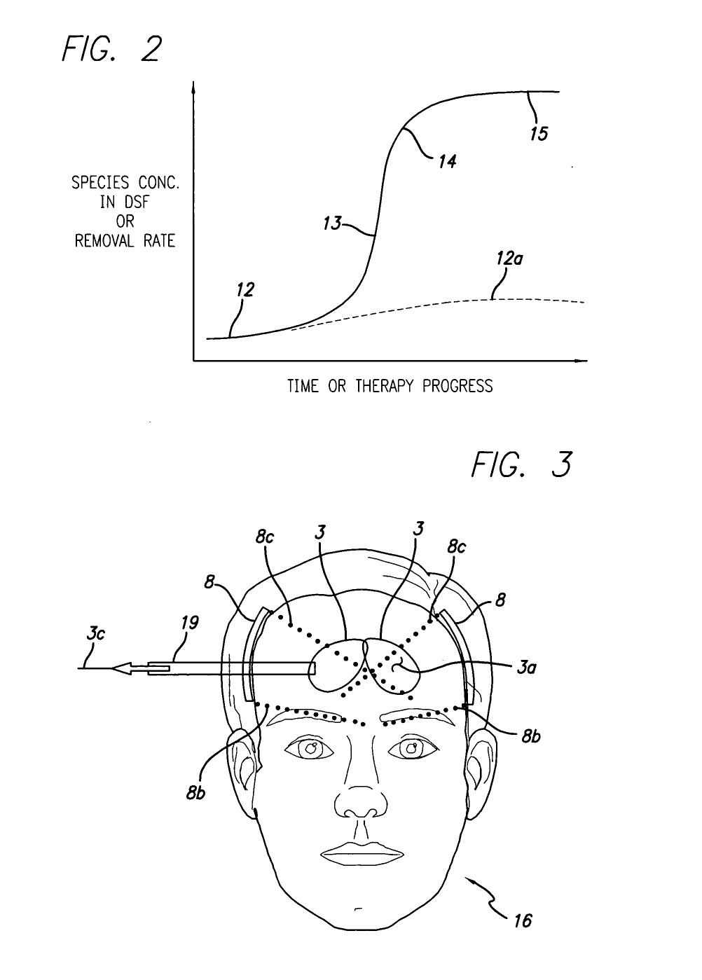

Referring now to FIG. 2, we depict the beneficial effects of the ultrasound exposure. Therein is a graph with the horizontal axis being time (or therapy progress) and the vertical axis being the concentration of an undesired species in the CSF in a CSF cavity. The dashed line 12a represents what happens with the use of a shunt alone. The solid line 12/13/14/15 represents what happens with the use of the ultrasound and the shunt. Sometime after time 12, we turn the ultrasound exposure on such that the concentration of the undesired species in the CSF follows trajectory 13. Note that the concentration of such species in CSF is significantly higher using the ultrasound per the above teaching. Because the concentration is higher in the CSF, then any CSF removed via shunting (or removed into the blood naturally or otherwise) will contain a greater amount of undesired species. Thus, it follows that with such higher removal rates that the brain will be exhausted of such species more quickly. At some point, the concentration, in the ultrasound case, will reach a maximum at 14/15, which is higher than that of the shunt-only at 12a. Eventually (not shown), both curves drop off as species are removed. Since the amount removed is proportional to the area under these curves, it is clear that more species can be removed faster using the ultrasound enhancement. Thus, our first preferred embodiment utilizes a shunt and ultrasonic exposure and an optional drug. Our second preferred embodiment, as mentioned previously, completely disposes with the shunt and relies on the ultrasound and/or drug to increase the movement of undesired species into CSF and/or into blood.

The main feature of FIG. 2 we wish to point out is that a higher species concentration 14/15 can be achieved in the CSF (or going into the CSF) with the aid of the ultrasound and optional drug than for the shunt-only curve at 12a. The shape of the shunt-only line 12-12a is only an estimated shape. Higher short-term concentrations 14/15 allow for faster removal of a given burden or load and/or a lower final remaining residual of “background” concentration.

So now it should be clear that the invention may be applied to quicken the removal of an amount of a species or to achieve a lower final residual concentration of a species. These may be complimentary results that go hand in hand. Now one can go back and look at the prior art shunts and realize that one can remove the same amount of species in less time with the acoustic enhancement. One can also remove the same amount of species in less total volume of extracted CSF. Since shunts are invasive and can cause infection, one can choose to use a shunt for a shorter period or use a smaller, less-invasive shunt.

A shunt frequently involves tapping through the skull to access the ventricle(s). Since once this is done it cannot easily be removed without more surgery, we also provide herein a new form of port. This new port replaces the conventional shunt and is merely a CSF-exchange port on the skull but not having the conventional attached shunt-lumens running to the abdomen or to an external bag. Thus, a lot of the infection and blockage/plugging issues are avoided.

One would, for example, insert a special syringe into the port and extract contaminated CSF. The extracted CSF could be simultaneously replaced with clean CSF, saline or other biocompatible liquid, perhaps using the same syringe. As an example, the “extraction” syringe could place fresh CSF or filler liquid, via a port with an interior lumen routed to a ventricle, directly into the ventricle located distal from the port. The port could be arranged to “leak” contaminated CSF coming from the region of the port or proximal to the port in amounts equal to the amount injected. Such an arrangement could be done at controlled CSF pressure. What this would allow is for the patient to walk in and get an ultrasound treatment and a port-tapping/-filling in one out-patient session. Such a port-only system would avoid many of the infection and blockage problems associated with full-blown shunts having lumen appendages running to the abdomen, for example.

Moving now to FIG. 3, a diagram of a patient's head 16 is shown. The patient is wearing a pair of acoustic transducers 8 delivering ultrasound energy defined by dotted lines 8b and 8c as described in our prior application (Ser. No. 10/612,171). Also shown in phantom are the known two large CSF ventricles 3 which contain CSF fluid 3a. A shunt 19 is shown tapping CSF from one such ventricle 3 and the extracted CSF 3c is carried away from the ventricle as outward shunt-flow 3c. In the prior art, the flow 3c would typically be redirected to the abdomen or peritoneal space for ultimate elimination from the body. We again emphasize that within the scope of the present invention is any dumping or cleaning/reintroduction of CSF or of blood in order to achieve a reduction in an undesirable neurodegenerative species. Per the above discussion, item 19 could also be a flush-mounted port as described, as opposed to a prior art shunt or a portion of such a prior art shunt. Such a port would be an effective biobarrier.

It will be appreciated in FIG. 3 that the ultrasound is shown passing through the skull and transiting at least some ventricle 3/brain (liquid/tissue) interfaces. Beginning with the ventricles 3, what this means is that the concentration of the undesired species in the CSF in the ventricles will increase per FIG. 2 such that shunt 19 flow 3c will be passing CSF outwardly, which now has a higher species concentration.

Secondly, since the ultrasound is indicated as passing through the superior surfaces of the cerebral hemispheres, we remind the reader that the arachnoid villi (not shown) will also be exposed. Thus, at least transitory opening of the villi may be achieved for enhanced outward flow of CSF into the blood, with the CSF carrying the undesired species, of course. Included within the scope of the present invention is opening of the arachnoid membrane or blood-brain-barrier (BBB), as described in our prior application (Ser. No. 10/612,171); however, herein any opening of the BBB may be for the purpose of allowing the undesired species to transit. It may also allow a drug to transit the BBB per the prior patent application regardless of whether undesired species transit the BBB.

Examples of ultrasound (acoustic) exposures are taught in our prior application. Such exposures are also adequate for the invention herein. Specifically, the following information is directed to the power and frequency utilized in the practice of the present invention.

The inventive system utilizes relatively low power intensities or densities as low as on the order of magnitude of diagnostic ultrasound imaging. Such low power densities, especially in non-CW modes, cause small temperature rises far, far lower than an ablation system wherein the temperature rise may be 50 to 100 degrees C. above tissue ambient for at least a very short period.

Low acoustic power densities are generally in the range of a few milli-watts per cm² to 10 watts per cm². Depending on how long such an illumination is switched on, the tissue will be warmed. For short times (millisecond to a few seconds range ultrasound pulses), the lower power densities above will raise the tissue temperature less than a few degrees C. during one such pulse, which will avoid tissue thermal-damage, known to happen around 43 degrees C. and above.

In terms of frequency, most aspects of the invention will work over broad ranges. For example, any emission between about 1 hertz to 2.5 megahertz will penetrate the skull. As noted in our prior application (Ser. No. 10/612,171), cooling can be used at the higher frequencies, but in the sub-megahertz range, cooling would probably not be required (low duty cycle would keep things cool enough), whereas in the 2 to 5 megahertz range and above, it would be preferred.

Both pulsed and continuous wave operation (CW operation) may be employed in the practice of the present invention. CW may be delivered for a finite ON period, typically from milliseconds to tens of seconds. We also include in the scope of the invention chirped operation and multitone or broadband operation (known in the ultrasound arts) as well as customized operation for a given patients skull/brain anatomical system. CW operation may also be arranged to be pseudo-CW operation in order to suppress cavitation, as is known to the art. Pseudo-CW means that the frequency varies with time somewhat so that inertial cavitation is suppressed.

In general, any emission which avoids most or all of the following may provide benefit using the invention: (1) avoid more than a 5 degree temp rise in significant quantities of living brain cells to avoid necrosis or thermal cell death of any type, (2) avoid direct unaided (inertial) cavitation at least during CW pulses wherein the cavitation on-time will be very large and the damage accumulates quickly, and (3) avoid prolonged high peak acoustic pressures above 7 megapascals, especially in CW operation.

A new element here, however, is that if the arachnoid villi outward flow is to be enhanced acoustically, it may be best to do this with an intermittent exposure such that between exposures the transitory opening effect is still present but the acoustic-streaming flow (which is directed inwardly) does not hinder the outward movement of CSF into the blood. For example, the beam could be turned on and off for repeated one minute periods each.

So what we have taught is a means to enhance formation and/or transport of undesired neurodegenerative species ultimately out of the body. That enhancement may be with or without a shunt or our taught port and may involve one or both of enhanced movement into CSF and/or into blood. By neurodegenerative species, the person skilled in this art will realize from our prior application (Ser. No. 10/612,171) that such species may be reactants, products, by-products or intermediates of protein or prion-based deposit materials or the materials themselves. The point is that what is being removed is crippling the further increase in concentration of undesired proteins or prion materials or is, most preferably, actually reducing such concentrations in the brain and/or spinal cord.

We also remind the person skilled in the art that the referenced art taught that the “shunt” may optionally incorporate an external (or internal) dialysis or filtering means such that some or all of the CSF can be reintroduced into the patient's body.

Finally, we expect that acoustic illumination of the brain may also beneficially enhance the production of new CSF by illumination of one or more of the choroid plexuses, the vasculature of the subependymal region, or of the pia matter. These production sites are described in the above-referenced patents. As long as the pressure and/or flow of the CSF can be kept under control as by the use of the referenced shunt structures, this effect will only further dilute the undesired species. Thus, we expressly also include enhanced CSF production, alone or in combination with the other mechanisms taught herein, to be within the scope of the present invention.

Summarizing, an apparatus and method are disclosed for providing therapy to a patient having, or who may potentially develop, a neurodegenerative disease characterized by abnormal proteins or prions or related deposits. The apparatus comprises:
(a) emitter means to deliver acoustic, ultrasonic or vibratory energy in, into, through, toward, from within or coupled-into a region of the patient's brain or spine which contains, or is in transportable communication with, cerebrospinal fluid (CSF) or blood capable of bearing or bearing a chemical or biological species, reactant, fragment, by-product or species related to the disease;
(b) the emitter operable to at least one of: (1) enhance, promote or enable, directly or indirectly, the formation and/or transport of the species, reactant, fragment or byproduct which is at least ultimately transportable out of a brain or spine region and into a CSF space, lumen, cavity or bloodstream, (2) enhance the transport or mixing of the species within CSF and/or blood or across tissues or existing barriers and membranes, and (3) enhance or promote the increased production of fresh CSF or blood;
(c) at least one of the enhanced formation, transport, mixing or production contributing at least ultimately to some removal of the species from the body and/or at least some immediate or later reduction in concentration of the species in a portion of the body at least in part by using one or more natural paths, emitter-enhanced paths, drug-enhanced paths, surgical or artificial shunting means, port means, or internal or external dialysis or filtering means, thereby at least slowing or stopping a disease process; and
(d) the patient optionally receiving a drug before, during or after an operation of the emitter(s) to at least one of: (1) act or help act against a disease process or a contributing factor thereto, (2) promote the formation or transport of a species that is to be removed or is more easily removable than a natural species, (3) encourage or enable growth or regrowth of new or transplanted brain or stem cells or enhance functional brain or neural pathways, (4) encourage or enable the beneficial uptake, processing or interaction of a genetic medicament, and (5) minimize potential or expected side-effects of an emitter exposure or shunting or port procedure., at least one such drug acting at least one of independently of, in cooperation with, or synergistically with an acoustic exposure.

The apparatus and method may accelerate or enable diffusional, perfusive or other mass-transport of species across a brain/CSF interface, brain/blood interface, CSF/blood interface, membrane, interface or blood-brain-barrier in any direction. Alternatively, the apparatus may accelerate diffusional, perfusive or mass-transport of species or of CSF or of any CSF-contained species across the arachnoid villi or arachnoid membrane in any direction.

The apparatus and method may provide acoustically driven stirring, streaming, perfusion or flow of blood in a blood flowpath/lumen or of CSF in a CSF cavity or lumen, the enhanced or initiated flow contributing to mass transport of a species in a direction useful for its natural or artificial removal from the body.

The apparatus and method may operate in cooperation with or in support of a shunt, a port, a filtration or dialysis means, or any means used to controllably extract or cleanse CSF or blood of a species having relevance to a neurodegenerative disease process.

The apparatus and method may operate in at least one of the following manners:
(a) it provides or encourages, at least in part, at least some increased production of fresh or new CSF;
(b) it allows for the use of a port rather than a shunt;
(c) it allows for the shorter-period deployment of a shunt or port or the entire avoidance thereof;
(d) it allows for a shunt or port to remove CSF or undesired species more quickly or more safely such as at a lower flow rate or at a more benign pressure;
(e) it enhances the body's own removal rate for an undesired species at least temporarily;
(f) it allows for the avoidance of the use of at least one of a shunt or port;
(g) it provides ultrasound-assisted drug therapy supportive of the slowing or stopping of a neurodegenerative disease;
(h) it treats Alzheimer's Disease or factors thought to lead thereto;
(i) it increases transport of an undesired species or a species involved in a neurodegenerative disease process into the bloodstream or into CSF; and
(j) it interferes with a disease pathway, whether physical, chemical, biological or genetic.

In one embodiment, the emitter means may be located outside the body of the patient. In another embodiment, at least one emitter may be located outside the skull of the patient. In the latter case, therapeutic acoustic or vibratory energy is directed or passed through or across at least a portion of the patient's blood-brain barrier, arachnoid-villi, arachnoid membrane or skull bone. At least some of the therapeutic acoustic or vibratory energy may open at least a portion of the blood-brain barrier, arachnoid-villi or arachnoid membrane, at least temporarily, for enhanced passage at least one of inwards or outwards, of medicaments, drugs, byproducts of the deposition therapy process itself or of a disease species. Further, the therapeutic acoustic or vibratory energy is at least one of: (a) below the unaided cavitation threshold and therefore blood brain barrier opening via unaided cavitation mechanisms is largely avoided, (b) above the unaided cavitation threshold and therefore cavitation significantly aids the opening of the blood brain barrier, (c) above a reduced energy level required to cavitate or excite an administered microbubble, microparticulate or other cavitation or excitation agent such that its vibrational motions significantly aids opening of the blood brain barrier, and (d) sufficient to enable or enhance transport of blood or a disease species across the arachnoid villi.

In another embodiment, at least one emitter may be located inside the body of the patient. In this case, at least one emitter may be located inside a skull boundary or skull of the patient. Alternatively, at least one emitter may be located in a natural neurological lumen, cavity or passage adjacent to or within the brain or neurological system and the emitter is capable of emitting or directing therapeutic energy into a surrounding, adjacent or nearby brain or neurological region. Yet alternatively, at least one emitter is located in or delivered into the skull via access through a craniotomy, other skull borehole or opening, via any natural body lumen, through the vascular system or through a natural interior space or cavity.

At least one emitter may be operated at least a portion of the time with at least one operating characteristic selected from the group consisting of continuous wave operation (CW), pulsed wave operation (PW), single-pulse operation, shaped-pulse operation, multipulse operation, pulse-train operation, broadband operation, narrowband operation, chirped operation, multitone operation, multifrequency operation, having a harmonic frequency, having a pre-determined waveform, having controlled duty-cycle operation, having a predetermined frequency component or spectrum, having a fundamental or primary frequency, having a variable frequency, having a predetermined constant or variable amplitude, emitting a compressive and/or rarefaction wave, emitting a shear wave, or having a frequency useful for manipulating a micro-bubble, microparticle or contrast agent.

The output from at least one emitter is at least one of focused, collimated, weakly focused, unfocused, diffused, diffuse, defocused, beamformed, steered or wiggled in any manner. In one embodiment, formation of the output from at least one emitter employs electronic phase-delays applied across subelements within one or more individual emitters or across different emitters such electronic beam-steering or beam-forming takes place. In another embodiment, formation of the output from at least one emitter employs mechanical shaping of an acoustic component of one or more individual emitters such that at least one the emitter utilizes a mechanically-shaped acoustic component for shaping acoustic emission from at least that emitter.

Multiple acoustic or vibration emitters may be employed in the practice of the present invention, at least some of the emitters temporally capable of at least one of individual, simultaneous, sequential, interleaved, overlapping, and phase-delayed operation relative to at least one other emitter. In this connection, at least some emitters may be arranged in at least one of the following manners:
(a) at least one of the emitters is one of mechanically defocused, mechanically collimated, mechanically weakly focused, mechanically focused, or mechanically diffused or diffuse and the multiple emitters together allow for greater total brain-volume coverage or skull-area coverage than that offered by a single the emitter;
(b) the arrangement of (a) but wherein electronic phase-delay firing between at least two the emitters is also used for purposes of beam forming, steering, slewing or wiggling of emissions;
(c) the arrangement of (a) or (b) wherein phase delays are applied within at least one the emitter possessing at least two subelements such that at least one the emitter can internally provide some beam manipulation or slewing;
(d) at least one the emitter is mounted in or to a receptacle, hole or locating mechanism in or on a headpiece designed to hold or position at least one emitter;
(e) at least one the emitter can be attached to, mounted upon or located by the patient's headpiece in more than one possible position or angle relative to the skull;
(f) at least one the emitter is mounted in, on or located by the patient's headpiece in response to known brain or neural therapy target positions as determined by a brain or neural image;
(g) at least one the emitter is acoustically coupled into a patient's brain or neurological region, with or without the aid of a headpiece or other emitter housing or locating means; and
(h) at least one the emitter is acoustically coupled into the skull or a therapy target region using an intermediate acoustically conductive film, gel, paste, cream or liquid.

At least one emitter may incorporate, be thermally coupled to, or be thermally managed or monitored by a cooling means, temperature control means or temperature monitoring means which controls or monitors the temperature of at least one of (a) at least one emitter, (b) any portion of a patient's anatomy, (c) the temperature or flow of a coolant, and (d) the temperature of an acoustic couplant material juxtaposed to an emitter. In this connection, at least one temperature of at least one portion of the patient's anatomy is monitored, deduced or projected and utilized in controlling, limiting, adjusting or setting a power delivery parameter of the system, manually or automatically.

In yet a still further embodiment of the placement of the emitter(s), at least one emitter may be located inside the patient's skull, the emitter capable of emitting acoustic or vibration therapy energy into at least one selected adjacent or affected brain or neurological region, the emitter being at least one of: (a) an emitter which emits a fixed beam relative to itself, (b) an emitter which emits an electronically steerable beam, steerable relative to itself, (c) an emitter which can have its beam mechanically steered or moved via physical movement of the emitter itself or of an interior portion thereof, and (d) an emitter which emits a focused, weakly focused, collimated, defocused, unfocused diffused or diffuse emission pattern.

The system may be sufficiently portable that it may be operated in at least one of: (a) at a patient's home, (b) at a clinic, (c) at a nursing home, (d) at a doctor's office, (e) at an out-patient facility, (f) next to a chair or bed in which the patient resides, (g) at a chosen hospital bedside, and (h) in a manner allowing the patient to view or hear music, television or video content and thus be simultaneously entertained.

In the use of the apparatus of the present invention, at least one brain or neurological region may be chosen for a therapy exposure or session, or such an exposure or session may be designed, planned or monitored with the help of at least one of the following:
(a) at least one radiological, diagnostic or functional image or graphic representation of the patient's brain, brain function, metabolism, neurology or neurological function or disease state;
(b) at least one statistical model or database based on a relevant patient or human population;
(c) at least one lab-test or clinical test performed on the patient or on at least one patient's lab specimen, invasively or noninvasively; and
(d) at least one incidence of at least one of the above choosing, designing or monitoring methods taking place at least once before, during or after a therapy.

In connection with the foregoing, the image or graphical representation may be obtained using at least one of: positron-emission tomography (PET), single photon emission computed tomography (SPECT), functional positron emission tomography (fPET), magnetic resonance imaging (MRI), functional magnetic resonance imaging (fMRI), computed tomography (CT), computer aided tomography (CAT), X-Ray imaging, fluoroscopy, and ultrasound imaging (US) or using a spectroscopy technique based on one or more of these tools.

Also in connection with the foregoing, the statistical model or database may be one based on at least one of: (a) a database including living or deceased patients, (b) a database including genetic tendencies to acquire the disease or of genetic test results, (c) a database including risk factors for the disease, (d) a database including lab-test or clinical-test results, (e) a database including data from the patient, (f) one or more radiological, diagnostic or functional image of at least one patient, and (g) any patient record or report.

In the use of the apparatus of the present invention, a parameter of a given therapy session or a number of or parameter of further sessions to be undergone may be determined, at least in part, by the use of at least one lab-test or by a radiological, diagnostic or functional image or graphical representation which provides information relating to the current state, a recent state or an anticipated state of the disease in the patient. In this connection, at least one lab-test may involve the taking or observing of a sample or portion of bodily fluid or bodily tissue and the sample may be either non-invasively observed or may be physically taken from the patient at least once, at least temporarily, before, during or after a therapy. Further in this connection, at least one the lab-test may involve the observation, recording or measurement of a property or state of the patient's spinal fluid, blood, urine, skin, tissues, other bodily fluid or physiological parameter and the lab-test may be performed on the patient or on patient's sample at least once before, during or after a therapy invasively or noninvasively.

In the use of the apparatus of the present invention, an abnormal protein-related or prion-related disease affecting or expected to potentially affect the patient's brain or neurological system, directly or indirectly, may be diagnosed to possibly, likely or certainly be one or more of: Guam-Parkinsonism dementia complex, Dementia Pugilistica, Parkinson's Disease, adult Down Syndrome, Subacute Sclerosing Panencephalitis, Pick's Disease, Corticobasal Degeneration, Progressive Supranuclear Palsy, Amyotrophic Lateral Sclerosis/Parkinsonism Dementia Complex, Hallervorden-Spatz Disease, Neurovisceral Lipid Storage Disease, Mediterranean Fever, Muckle-Wells Syndrome, Idiopathetic Myeloma, Amyloid Polyneuropathy, Amyloid Cardiomyopathy, Systemic Senile Amyloidosis, Hereditary Cerebral Hemorrhage with Amyloidosis, Alzheimer's Disease, Scrapie, Creutzfeldt-Jacob Disease, Fatal Familial Insomnia, Kuru, Gerstamnn-Straussler-Scheinker Syndrome, Medullary Carcinoma of the Thyroid, Isolated Atrial Amyloid, Beta2-Microglobulin, Amyloid in dialysis patients, Inclusion Body Myositis, Beta2-Amyloid deposits in muscle wasting disease, Islets of Langerhans Diabetes Type2 Insulinoma or the Polyglutamine diseases including Huntington's Disease, Kennedy's Disease, and all forms of Spinocerebellar Ataxia involving extended polyglutamine tracts.

In a preferred embodiment, the disease is a form of Alzheimer's Disease and at least one type of or quantity of undesired plaque or deposit is being formed or is expected to form. Specifically, a targeted plaque or plaque-forming process may be related to at least one of senile plaque and fibril plaque formation contributing to a current or anticipated form of Alzheimer's disease.

In the use of the apparatus of the present invention, at least one of a drug, medicament, vitamin, mineral or controlled dietary matter or content may be either (a) utilized in support of or in cooperation with at least one plaque or prion related breakup-process, formation-interference process, or disease recovery process such that the total overall therapy delivered over one or more therapy sessions incorporates the use of the drug, medicament, vitamin, mineral or dietary matter or content and the use of the acoustic or vibratory exposure therapy, with the drug, medicament, vitamin, mineral or controlled dietary matter or content and the acoustics or vibrations being used simultaneously, sequentially or both, or (b) employed, at least in part, to ameliorate the side effects of any acoustic or vibratory exposure itself, or (c) an anti-inflammatory. In this connection, at least one acoustic or vibratory therapy exposure, directly or indirectly, at least one of enhances, enables, accelerates, initiates or extends the action of the drug, medicament, vitamin, mineral or controlled dietary content in terms of treatment rate or completeness of the extent of treatment benefit.

The foregoing enablement, enhancement, initiation, extension or acceleration is at least one of: (a) caused by the action of the acoustic or vibratory energy upon the at least one drug, medicament, vitamin, mineral or ingested controlled dietary matter or content and (b) caused by the action of the acoustic or vibratory energy on the anatomy, body tissue or body fluids of the patient, thereby favorably preparing the anatomy, tissue or body fluid for subsequent and/or simultaneous exposure to the at least one drug, medicament, vitamin, mineral or controlled dietary matter or content.

The drug(s), medicament(s), vitamin(s), mineral(s) or controlled diet(s) may provide anti-inflammatory or anti-ischemic benefit. The drug(s), medicament(s), vitamin(s), mineral(s) or ingested dietary content(s), at least in part, may reach a brain or neurological region by passing through the blood-brain barrier (BBB), arachnoid membrane or arachnoid-villi, either unaided or in aided form, wherein the aid comprises one of:
(a) the use of at least one form of a drug, medicament, vitamin, mineral or controlled dietary ingested content known to chemically open the BBB, membrane or villi to itself or to the ingress of another therapeutic drug;
(b) the use of the acoustic or vibratory energy to open the BBB, membrane or villi via cavitation, bubble oscillation, heating or any other mechanisms;
(c) the use of the acoustic energy to drive, transport or diffuse the at least one drug, vitamin, mineral or controlled dietary ingested content through the BBB, membrane or villi without cavitation mechanisms predominating the driving;
(d) the use of a combination of the at least one drug, vitamin, mineral or controlled dietary content opening the BBB, membrane or villi and also itself delivering therapy to the brain or neurological regions of interest; and
(e) the use of at least one drug, medicament, vitamin, mineral, ingested dietary content, acoustic energy or exposure or vibrational energy or exposure to either improve the flow of a CSF constituent into the blood or to open at least portions of the arachnoid-villi.

In an embodiment, the acoustic or vibratory exposure of at least some brain or neurological tissues accelerates or enables, directly or indirectly, the perfusion, diffusion, transport, or physical, chemical or biological therapeutic action of the drug(s), medicament(s), vitamin(s), mineral(s) or controlled ingested dietary matter or of a reactive species or product thereof.

In another embodiment, acoustic streaming, acoustic radiation-pressure or acoustic-cavitation developed in or near the brain or neurological region by the acoustic or vibratory exposure may assist in transport, perfusion, diffusion, disbursement, delivery or distribution of the drug(s), medicament(s), vitamin(s), mineral(s) or controlled dietary ingested matter or of a subspecies, constituent or byproduct thereof.

In yet another embodiment, the drug(s), medicament(s), vitamin(s), mineral(s) or controlled dietary matter may comprise or include at least a microbubble or microparticulate agent administered or ingested into the body, into the blood, into a tissue or bodily fluid or into a brain or neurological region. The agent may provide for enhanced or reduced power-threshold cavitation or bubble oscillation when under acoustic or vibratory illumination. The enhanced cavitation or oscillation at least micromechanically and therapeutically may contribute to at least one of a plaque breakup, formation-interference, or disease-aiding therapy process. In this connection, the the microbubble or microparticulate may also act as a drug or medicament carrier or drug-bearing medium, with at least one therapeutic drug or medicament emanating from the microbubbles or microparticles at some point after administration or ingestion into the body of the patient. The emanation may take place by natural leakage, diffusion or release of drug from the microparticles or by acoustically excited release, diffusion or leakage from the particulates.

In a still further embodiment, the drug(s), medicament(s), vitamin(s), mineral(s) or controlled dietary matter supporting the therapy, directly or indirectly, may include at least one of: 4-hydroxynonenal, acetylcholinesterase or acetylcholine modulators, 1-amino-3,5-dimethyladamantane hydrochloride, acetyl-1-carnitine, alpha 2-macroglobulin drugs, alpha-synuclein or synuclein modifiers or modulators, antibodies, anti-coagulants, anti-inflammatories, anti-ischemics, anti-oxidants, anti-sense drugs, apolipoprotein or apolipoprotein-gene modifiers or modulators, apomorphine-based molecules, donepezil, aspirin, beta-secretase modifiers or modulators, biological reducing agents, celecoxib, 5-aminosalicyclic acid, chelation modulators or agents, cholesterol modulators, cholinergic drugs, coenzyme Q10, tacrine-hydrochloride, cognition-enhancing drugs, cyclooxygenase-2 (COX-2) inhibitors, C-terminal tau inhibitors, diets controlling calories or fat, diets providing anti-oxidants, diets providing vitamins or minerals, domain ligands, donepezil, diazespam, drugs which affect protein kinase C pathways or tyrosine kinase pathways or phosphotyrosine pathways, drugs which affect copper or zinc binding to clioquinol, drugs which modulate aluminum, zinc, copper, iron, fluoride or calcium species, estrogen, drugs which affect APP protein or mutant APP, drugs which affect any one of APOE or APOEe4 or any APOE allele, drugs which affect presenilin protein or presenilin 1, drugs which affect a proteolysis function, drugs which affect tau genes or tau mutations, drugs which affect the behavior of chromosome 17, drugs which reduce oxidative damage, drugs which reduce oxidative damage to RNA, drugs which reduce free radicals, estrogen-like drugs or estrogen-like replacement therapies (ERTs), drugs which treat the cholinergic system, rivastigmine tartrate, folate or folic acid modulators, galantamine, gamma-secretase drugs, gene delivery drugs, genetically engineered drugs, Ginkgo Biloba, glutamate modulators, homocysteine modulators, hormones, Hydrochloride, hyperzine A, H₂O₂ modulators, ibuprofen, immunomodulating drugs, indomethacin, inflammatory cytokines, insulin degrading enzyme IDE, iron modulators or modifiers, ketone drugs, kinesin-1 modulators, leteprinim potassium, lithium, M-CSF or macrophage colony stimulating factor, memantine, mimetics, monoclonal antibodies, matrix metalloproteinase (MMP) modulators, leteprinim-potassium, neurotrophic factors, neural growth factors (NGFs), notch protein drugs, non-steroidal anti-inflammatories (NTHES), nitric oxide modulators, parkin gene modulators or modifiers, peptides, plasmins, PP1 enzyme blockers, prednisone, prodrugs, protease inhibitor gene drugs, protein-kinases, proteolytic antibodies, R-flurbiprofen, galantamine HBr, rivastigmine, serum nerve growth factor, rofecoxib, statins, stem-cells or stem-cell derived medicaments, steroids, tacrine, transplanted cells, transplanted cell constituents, transplanted genetic materials, transplanted body fluids or fluid constituents, triterpenoids, ubiquitin-C-hydrolase-L1, vaccines, rofecoxib, vitamins, Vitamin C, and Vitamin E, beta-amyloid modifiers or modulators, tau modifiers or modulators, vaccines, PYM50228, gamma-aminobutyric acid (GABA), GABA-like drugs, muscimol, benzodiazepines, Wnt, beta-catenin, HoxB4, and talsaclidine.

The patient may at least one of be administered, ingest or take a drug, medicament or controlled dietary matter before, during or after at least one acoustic or vibratory exposure, the drug or medicament reaching a tissue to be treated, directly or indirectly, before, during or after an exposure to the acoustic or vibratory energy.

The drug(s), medicament(s), vitamin(s), mineral(s) or controlled dietary matter or content may be used for at least one of: (a) to provide, enable, initiate, extend or accelerate at least one plaque, protein or prion breakup process, formation-interference process, or disease recovery process and (b) to ameliorate a side-effect of the acoustic or vibratory exposure. The drug(s), medicament(s), vitamin(s), mineral(s) or controlled dietary matter or content may be administered, ingested, taken-in, therapeutically delivered, provided, prescribed or recommended to the patient.

In this connection, the administration or intake may be via (a) oral ingestion by eating or drinking, (b) nasal or oral inhalation, (c) injection or introduction anywhere into the body of the patient, either percutaneously, transdermally or via a natural orifice (d) metered or controlled release from outside or inside the body of the patient, (e) via a skin-patch, (f) via a catheter or port, or (g) via the delivery of genetic or cellular materials from outside the body.

Further, the administration, provision or intake may be via metering or controlled release from a pump, injector or other flow, flow-direction, or pressure-controlled source located anywhere outside or inside the body of the patient

In an embodiment of the use of the apparatus and method of the present invention, the acoustic or vibratory exposure may provide, initiate, extend, enable or accelerate to a useful degree the rate or extent of at least one the breakup, interference or aiding process via mainly acoustic-driven mechanisms without the required use of medicaments, vitamins, minerals or controlled dietary ingested matter for the providing, enabling or acceleration.

In an embodiment of the use of the apparatus and method of the present invention, at least one acoustic or vibratory exposure is arranged or chosen to utilize at least one acoustic or vibratory wavelength which bears a calculatable or histological relationship to a characteristic dimension of a plaque, fibril or prion-related deposit or defect. The choosing may cause a desirable mechanical interaction between the plaque, fibril, nodule or defect and the acoustic or vibratory waves, thereby micromechanically contributing to at least one of the breakup, interference, and aiding processes. In this connection, the characteristic dimension is approximately that of a representative plaque, prion, protein, fibril, nodule, defect or deposit dimension.

In an embodiment of the present invention, a cooling or heat-exchange means may be provided that is in thermal communication with at least one of: (a) an emitter, (b) any of the anatomy of the patient, and (c) the skull of the patient, and heat flows directly or indirectly either to or from the cooling or heat-exchange means to or from at least one of an emitter, a patient's anatomy or a patient's skull.

Such cooling or heat-exchange means may provide for: (a) controlling or limiting the temperature of at least one emitter, directly or indirectly, (b) controlling or limiting the temperature of at least a portion of the patient's anatomy or of the skull of the patient, directly or indirectly, or (c) the use of higher acoustic powers than would otherwise be possible without use of the cooling or heat-exchange means, while maintaining safe maximum patient temperatures.

The apparatus of the present invention may further include at least one of: (a) a cooling or heat-exchange means for transferring heat to or from at least one emitter, from a portion of the patient's anatomy, or from the skull of the patient and the operation of an included cooling or heat-exchange means may be in response or in support of the operation of at least one emitter or to temperatures caused thereby in the skull or anatomy, and (b) a drug, medicament, vitamin or mineral delivery means providing a drug, medicament, vitamin or mineral in support of at least one plaque, protein or prion breakup process, formation-interference process, or disease therapy processes, the drug, medicament, vitamin or mineral being delivered to the patient responsive to at least one of a flow control, a pressure control, a dosage control, a blood-concentration control, a sensor, a software or firmware program, a system control setting, a sensor, a timer, a real-time or individual-use lab-test or test-sampling, and a practitioner's direction.

In the apparatus and method of the present invention, at least one emitter's output may be mechanically scanned relative to the patient's brain, either by patient movement, system movement, emitter movement or emitter relocation on the headgear or a combination thereof.

The apparatus may further include a removable helmet, head-band or other juxtaposed or head-attached structure for securement to or juxtaposition to the head of the patient. The helmet or structure may incorporate or provide mounting, locating or positioning means for at least one emitter, the helmet/structure or emitter(s) therein or thereon becoming acoustically coupled to the patient, the coupling being achieved into or through the patient's scalp or skull, thereby allowing delivery of acoustics into the patient.

In this connection, the patient's head is at least partially in, enclosed by or surrounded by the helmet, head-band or head-attachment structure containing, supporting, locating or positioning at least one emitter. The structure may be at least partially supported by the apparatus yet also being mounted to or at least placed near or on the patient's head in order to perform the therapy.

Further in this connection, the patient's head may be in a helmet, head-band or head-attachment structure containing or having attached thereto or thereon at least one emitter, the structure having one or more of an umbilical, cable or coolant lumen which connects or is connectable to the system.

The apparatus may further include acoustic coupling means for coupling output from at least one emitter directly or indirectly into a tissue or body fluid of the brain or neurological system. The acoustic coupling means may utilize at least one of (a) an interposed liquid, gel, paste, cream, emulsion or acoustic-standoff, (b) an interposed inflatable fillable or soakable bag, membrane or sponge material, (c) an interposed acoustically water-like material. In this connection, the acoustic coupling means may also provide some skull size or shape adaptability for various-sized or shaped patient's heads for a given patient or from patient to patient.

In the apparatus and method of the present invention, operational set-up or compensation may be made for at least one of the following variables or changes: (a) variable skull thickness or shape from location to location on a given skull, or variable skull thickness or shape from patient-to-patient, (b) a variable skull, scalp or emitter temperature from location to location or at a single location over time, (c) a change in a relevant or representative brain or neurological temperature, (d) a change in a local or a nearby temperature in a general region of diseased or treated brain or neurological tissue, (e) a change in the result of an invasive or noninvasive lab-test monitoring a variable related to a state of the disease or to a state of a plaque-burden (f) a change in a metabolic or physiological instrument reading or patient-monitor, (g) a change in the patient's comfort level, (h) a change or variation in the acoustic velocity, attenuation or dimension of a patient's skull, skin, brain or neuro-logical tissue or plaque, (i) a change or variation in detected brain-tissue perfusion or in cerebral lumen blood-flow, (j) a change in the cavitation or oscillation behavior of a microbubble or microparticulate, (k) a change in an actual or desired concentration or of a delivery parameter of a drug, (l) a change in an actual or desired acoustic power to be delivered, (m) a change in the actual or desired concentration of a species of interest in a blood, urine, skin or spinal fluid test or ongoing sampling, (n) a change in a brain radiological or functional image or graphical representation, (o) a change in the amount of, nature of or presence of undesired side-effects being experienced or detected or anticipated, (p) a change in blood pressure or cerebrospinal fluid pressure, (q) a change in a state of inflammation whether due to the disease or the acoustics themselves, (r) a change in any brain function, (s) changes in locations or concentrations of plaque, fibrils or nodules within a single patient over time or from patient to patient, and (t) direction provided by software, firmware or by an operator or overseer of the system, regardless of whether any one of these is locally or remotely located.

In the apparatus and method of the present invention, acoustic or vibratory energy may also be utilized to diagnostically probe or measure a characteristic of the brain, skull, neurological system, disease state, physiology or temperature of the patient or operation of an emitter, the characteristic useful to set up, control or insure safe or efficient operation of the system.

The acoustic or vibratory emitter(s) may comprise an ultrasonic, acoustic or vibratory element which is electrically, electrostatically, magnetically, magnetostrictively, electromagnetically or optically driven or wherein the emitter is an acoustic output port coupled to an acoustic waveguide. The acoustic or vibration emitter(s) may be coupled, directly or indirectly, into the patient's brain or neurological system through at least one of an upper or lower jaw, neck or spine of the patient.

Further, the acoustic or vibratory coupling means may include:
(a) a shaved head or a head with reduced hair quantity;
(b) wetted hair using any hair-wetting material or a wetted scalp using any scalp-wetting material;
(c) wetted or gel-coated emitter or emitter portions;
(d) inflated or filled expandable acoustically-conductive bags, membranes or standoffs;
(e) provision of a saturatable or soakable material which acts as an acoustically transparent standoff or coupler in the soaked state;
(f) provision of a flexible or stretchable acoustically-transparent skullcap which is wettable or which promotes acoustically coupling on at least one inner or outer surface;
(g) provision of a flexible or stretchable skullcap which serves to control the patient's hair;
(h) flow or placement of an acoustically conductive liquid in an emitter/skull interface region;
(i) flow or placement of an acoustically conductive coolant or other heat transfer media in an emitter/skull interface region; and
(j) flow or placement of an acoustically conductive gel or paste in an emitter/skull interface region.

In the apparatus and method of the present invention, at least a portion of one plaque, protein or prion containing deposit, nodule or body may undergo at least one of shear, compressional or tensile-distortion or stress or may be excited into a vibratory mode by an acoustic or vibratory emission having a wavelength chosen to bear a relationship to a characteristic dimension of at least one of the deposit, nodule or body, the distortion, stress or vibratory behavior favorably contributing to at least one of the therapeutic breakup, interference, and aiding process.

At least one plaque, protein or prion-containing deposit, nodule or body may be, at least in part, one of spatially distributed, diffusely distributed, aggregated, agglomerated, intracellularly situated, extracellularly situated, fibril-like, plaque-like, may have a microscopic sheet structure or may be directly or indirectly associated with cognitive losses.

The acoustic or vibrational excitations in combination with an optional drug may provide a disease-therapy process in order to ultimately achieve at least one of: (a) enhanced perfusion, diffusion, transport or distribution of blood or cerebrospinal fluid or fluid constituents including disease species, (b) enhanced perfusion, diffusion, transport or distribution of a drug or medicament, (c) enhanced perfusion, diffusion, transport or distribution of a functional signaling chemical or species, (d) enhanced cognitive function, (e) enhanced transport of a plaque, prion or deposit break-down product or related debris, (f) enhanced perfusion, diffusion, transport or distribution of a medicament incorporating stem cells, living cells, or byproducts or derivatives of cells, whether natural cells or genetically manipulated cells, and (g) delivery or distribution of dead or living cells or cell constituents or derivatives serving as a vaccine.

At least one of the following may be employed: (a) the acoustic or vibratory exposure may contribute to enhanced cognitive function or a decrease in the rate of cognitive loss, and (b) the acoustic or vibratory exposure combined with the sequential or simultaneous use of a drug, medicament or controlled dietary intake both may contribute in at least some manner to enhanced cognitive function or a decrease in the rate of cognitive loss, regardless of whether the acoustic or vibratory energy provides, enables or accelerates the action of the drug, medicament or dietary content. In this connection, the acoustic or vibratory energy may provide, enable, accelerate or initiate a beneficial action of at least one drug, medicament or dietary contnet, either directly or indirectly.

The apparatus and method of the present invention may cause the concentration or activity of a chemical, genetic, cellular or biological material, reactant, product or byproduct which plays a damaging role or is involved in the damage sequence or chain of events of the neurodegenerative disease to be at least partly reduced, partly inactivated, chemically tied up or rendered inactive such that the rate of neural damage is slowed or stopped. In this connection, the activity or concentration may be reduced, tied up or made inactive accompanied by its ultimate removal from the body with the help of a natural body process, possibly acoustically enhanced, including at least one of: (a) brain metabolism, (b) brain perfusion or circulation of blood, (c) cerebrospinal fluid production or circulation, and (d) body excretion as waste. The acoustic or vibratory exposure may facilitate or accelerate the subsequent removal in any manner.

In the apparatus and method of the present invention, the patient may be subjected to at least one of the following:
(a) receive an initial lab-test, imaging session, diagnostic session or other exam or test in order to stage the disease or to understand the disease potential;
(b) receive a plaque, protein or prion material-breakup, formation-interference or disease-aiding therapy over a period of one or more sessions;
(c) receive a combination of at least two of breakup, interference or aiding therapies over a period of one or more sessions;
(d) receive at least one each of the breakup, interference, and aiding therapy in at least one session;
(e) receive at least one each of the breakup, interference, and aiding therapy over a period of two or more sessions;
(f) have a body fluid or tissue sample taken before, during or after at least one therapy session;
(g) have a body fluid or tissue analyzed or monitored invasively or noninvasively, before, during or after at least one therapy session; and
(h) undergo functional imaging or cognitive testing.

Cooling or heat-exchange may be employed to maintain, limit or control a temperature related to the patient's anatomy or to the therapy delivery means, regardless of whether the system is aware of the actual temperature present or temperature being controlled.

A wired, wireless, digital, analog, telephony, data, fiberoptic, video or network connection may be used for interaction with the therapy apparatus or patient from a distance or from a remote location.

In the apparatus and method of the present invention, multiple emitters may be employed, each primarily treating at least some unique emitter-assigned brain or neurological system region or subregion. Multiple emitters may be employed and there may a significant overlap in the treated or treatable regions or subregions addressable by the emitters. Multiple emitters may be employed in any manner and operated sequentially. Multiple emitters may be employed in any manner and operated simultaneously. Multiple emitters may be employed in any manner and at least two may be operated with controlled phase angle delays relative to each other. At least one emitter may comprise multiple acoustic subelements. At least one emitter may steer or shape emissions, at least in part, using a mechanically shaped acoustic component, At least one emitter may be moved among at least two different possible mountable positions or angles over a period of one or more therapies. At least one emitter may mate with electrical or coolant connectors predisposed in the helmet or headgear. At least one emitter structure may also serve to form the structure of the helmet itself. The helmet or headgear or emitter housing or holder may be, at least in part, directly made from material that is capable of emitting or receiving acoustic energy. The helmet or headgear may be mechanically mated to the patient during operation. The patient may rest or place his/her head juxtaposed against or to a pillow-like entity that holds an emitter. The headgear, helmet or pillow structure holding at least one emitter may also incorporate a thermal control means during operation. An emitter may be chosen for its frequency or penetration ability. An emitter may be chosen for its fit to the helmet or to the patient. The patient may sit, recline or lie down during the therapy. The patient may be entertained with audio and/or video content during the therapy. The patient may undergo therapy using a portable or semiportable system. The patient may undergo therapy at home, at a clinic, at a doctor's office, at an outpatient office, at a hospital or at a nursing home. The patient may intake a drug, medicament, controlled dietary content or therapeutic genetic or cellular substance before, during or after at least one therapy session, both the emissions and the drug contributing individually or cooperatively, to therapeutic benefit. Comfort or adjustability may be provided by an intervening acoustic standoff that is shapeable, the emitters passing their emissions through the standoff, the shapability adaptable to the patient's head. A shapeable acoustic standoff may serve as a conforming pillow for patient comfort or for improved acoustic coupling. A patient acoustic coupling means may incorporate a thermal control feature. An emitter itself may incorporate a connector or a thermal control means.

The acoustic or vibratory exposure may be of intensities or powers which allow for prolonged exposure or multiple exposures of the patient's brain or neurological system without accumulating unacceptable acoustically-induced permanent damage to neurologically significant portions of the patient's anatomy, tissues or fluids. Further, the acoustic or vibratory exposure may be of intensities or powers such that the accumulated time at temperature of treated brain regions is below that which would cause significant permanent thermal damage to healthy cells.

The ultrasonic or vibratory power per unit area may be between 5 milliwatts per square centimeter and 10 watts per square centimeter. In this connection, at least one of following may be carried out:
(a) at least one frequency between 1 hertz and 2 megahertz may be employed with or without cooling or heat-exchange;
(b) at least one frequency of between 2 megahertz and 5 megahertz may be employed with cooling or heat-exchange;
(c) the temperature rise in a portion of the patient's tissue or bodily fluid may be limited to 5 degrees centigrade or less;
(d) the duty cycle of the acoustic power may be set between 10 and 25% on-time; and
(e) healthy tissues may be spared permanent unacceptable thermal or acoustic damage.

At least one acoustic emitter may be inside the skull of the patient or in an interior location of the patient's brain or neurological system and acoustic or vibratory energy emanates in at least one direction generally outward toward a patient's scalp or toward a skinline.

Any emitter energy beam-forming or beam-steering may be done at least for the purpose of achieving increased or more uniform coverage of targeted or targetable brain or neurological regions.

The disease or incipient disease being treated may be, at least in part, resident in any of the following brain or neurological tissues: hippocampus, entorhinal cortex, cerebral cortex, posterior cingulated cortex, neocortex, allocortical regions, basal forebrain, or cerebellar tissues.

At least some of the acoustic or vibratory energy may be capable of providing, enabling, accelerating or initiating a plaque, prion or protein containing breakup-process, interference-process or disease-aiding process, the acoustic or vibratory therapy process itself not requiring a drug, medicament or controlled dietary content to proceed at a useful pace or to a useful extent. In this connection, the breakup, interference or aiding process may enhance patient cognition at least after some time has passed.

A drug, medicament or controlled dietary content may be used to comfort the patient or to relieve existing or potential side-effects of an acoustic or vibratory exposure, regardless of whether it contributes to the therapy itself.

In accordance with an aspect of the present invention, cognition loss may be at least slowed, stopped or reversed at least after some time has passed.

The primary physical components of the apparatus may include a console or control box, a headpiece incorporating at least one emitter, and at least one connecting or connectable cable or lumen connecting the console and the headpiece.

A bodily fluid such as blood or cerebrospinal fluid may be manipulated in any manner in cooperation with at least one the acoustic or vibratory exposure or by the exposure, the combined exposure and manipulation having at least one of additive, extending or acceleration-of-therapy effects.

In accordance with an aspect of the present invention, a method for the therapeutic treatment of abnormal protein-related or prion-related diseases of a human patient's brain or neurological system comprises:
(a) coupling at least one acoustic or vibratory emitter into a patient's brain or neurological system or portion thereof; and
(b) exciting the emitter to emit acoustic or vibrational energy with a desired characteristic directly or indirectly into or through the brain or neurological system or portion thereof, the emitted energy designed to provide, enable, accelerate or initiate at least one of the following therapy processes in cooperation with the optional use of a drug:
   (1) physical breakup, breakdown, erosion, dispersion, disentanglement, de-aggregation, redistribution, dissolution, de-agglomeration, de-amalgamation or permeation of at least some disease-related deposits, nodules or bodies thereby improving the transport of a disease species out of the body by at least one of a shunt, a port, a natural bodily process, an energy-enhanced natural bodily process, natural or enhanced bloodflow, or by natural or enhanced CSF flow,
   (2) at least temporary opening of the blood-brain-barrier (BBB) or arachnoid-villi for the purpose of enabling or improving the transport of a disease related species out of the body by any means including artificial shunt or port means and enhanced arachnoid-villi flow,
   (3) acoustic or vibrational stirring or mixing of blood or cerebrospinal fluid for the purpose of enabling or improving the transport of a disease related species out of the body by any means including artificial shunt or port means or any natural bodily means;
   (4) enhancing the transport of a disease-related species by enhancing or enabling CSF or bloodflow via acoustic streaming effects or by acoustic exposure causing at least temporary increases in membrane or tissue permeabilities, and
   (5) drug-aided attack upon the deposits, nodules or bodies wherein the acoustic energy at least one of (i) aids in transporting the drug, (ii) activates the drug, (iii) enhances the benefit delivered by the drug, (iv) enhances the rate or extent of attack of the drug upon the deposits, nodules or bodies, and (v) has accelerated or extended benefit because of the cooperative action of the drug.

In the foregoing method, a drug, medicament or controlled dietary content may optionally be administered to enhance therapy effectiveness or patient comfort, independently or in cooperation with the emitted energy. In this connection, the drug, medicament or dietary content which is administered may be at least one of: (a) known to provide useful therapy even without the acoustic emissions present, and (b) requires acoustic emissions to directly or indirectly cause the drug to be of therapeutic benefit. Further in this connection, an administered drug, medicament or dietary content may have its therapeutic contribution enabled, enhanced, initiated, accelerated or extended due to an effect, latent effect or side-effect of at least one acoustic exposure.

In the foregoing method, the acoustic emissions may be unfocused, weakly focused, diffused, diffuse, collimated or overlapping spatially or temporally.

Also in the foregoing method, the drug may also serve as an imaging contrast agent or serves to minimize an undesirable side-effect of the acoustic exposure.

Further in the foregoing method, acoustic measurements or imaging may be practiced in support of the therapy, regardless of whether any of the therapy emitters are also used for the measurements or imaging.

Still further in the foregoing method, blood or cerebrospinal fluid may be otherwise manipulated in cooperation with the emission therapy, the manipulation comprising at least temporary shunting of blood or cerebrospinal fluid.

In accordance with another aspect of the present invention, a method for providing therapy to a patient having, or who may potentially develop, a neurode-generative disease characterized by abnormal proteins or prions or related deposits comprises:
(a) delivering acoustic, ultrasonic or vibratory energy in, into, through, toward, from within or coupled-into a region of the patient's brain or spine which contains, or is in transportable communication with, cerebrospinal fluid (CSF) or blood capable of bearing or bearing a chemical or biological species, reactant, fragment, by-product or species related to the disease;
(b) the emitter operable to at least one of: (1) enhancing, promoting or enabling, directly or indirectly, the formation and/or transport of the species, reactant, fragment or byproduct which is at least ultimately transportable out of a brain or spine region and into a CSF space, lumen, cavity or bloodstream, (2) enhancing the transport or mixing of the species within CSF and/or blood or across tissues or existing barriers and membranes, and (3) enhancing or promoting the increased production of fresh CSF or blood;
(c) the enhanced formation, transport, mixing and/or production contributing at least ultimately to some removal of the species from the body and/or at least some immediate or later reduction in concentration of the species in a portion of the body at least in part by using one or more natural paths, emitter-enhanced paths, drug-enhanced paths, surgical or artificial shunting means, port means, or internal or external dialysis or filtering means, thereby at least slowing or stopping a disease process; and
(d) the patient optionally receiving a drug before, during or after an operation of the emitter(s) to at least one of: (1) act or help act against a disease process or a contributing factor thereto, (2) promote the formation or transport of a species that is to be removed or is more easily removable than a natural species, (3) encourage or enable growth or regrowth of new or transplanted brain or stem cells or enhance functional brain or neural pathways, (4) encourage or enable the beneficial uptake, processing or interaction of a genetic medicament, and (5) minimize potential or expected side-effects of an emitter exposure or shunting or port procedure., at least one such drug acting at least one of independently of, in cooperation with, or synergistically with an acoustic exposure.

In accordance with yet another aspect of the present invention, a method of at least temporarily slowing, stopping or avoiding a patient's cognitive losses associated with a neural deposition disease is provided. The method comprises administration of acoustic or vibrational energy directly or indirectly into affected or potentially affected patient anatomy portions thereby causing at least one of: (i) acoustically enhanced or enabled beneficial transport of a disease-related species into, to, through or out of a CSF or blood transport path, (ii) acoustically enhanced or enabled beneficial transport of a disease-related species into, to, through or out of a ventricle, bodily lumen, bodily organ, shunt, port or artificial fluid extraction means, (iii) acoustically enhanced or enabled beneficial transport of a disease-related species across a blood-brain-barrier (BBB), arachnoid-villi, or across any membrane or tissue, and (iv) acoustically enhanced or enabled beneficial increases in the bodily production of fresh CSF.

In the foregoing method, at least one of the following is practiced:
(a) imaging diagnostics in support of at least one the therapy treatment;
(b) performance of a lab or clinical test upon the patient or his/her body or bodily specimens in support of at least one the therapy treatment;
(c) cognitive testing or grading in support of at least one the therapy treatment;
(d) delivery of a drug or medicament to the patient in any form, the drug acting independently or in cooperation with the acoustic or vibratory therapy;
(e) vascular delivery of an acoustic or energy emitter or energy source:
   (1) through-skull or skull borehole delivery of acoustic energy or energy source,
   (2) CSF or blood removal, temporary or otherwise, or
   (3) CSF or blood filtering or dialysis performed in or outside of the body;
(f) at-home, out-patient, doctors office or clinical delivery of at least one therapy session; and
(g) one or more therapy sessions regardless of how many visits that requires of the patient, if any.

1. An apparatus for providing therapy to a patient having, or who may potentially develop, a neurodegenerative disease characterized by abnormal proteins or prions or related deposits comprising:
(a) emitter means to deliver acoustic, ultrasonic or vibratory energy in, into, through, toward, from within or coupled-into a region of the patient's brain or spine which contains, or is in transportable communication with, cerebrospinal fluid (CSF) or blood capable of bearing or bearing a chemical or biological species, reactant, fragment, by-product or species related to the disease;
(b) the emitter operable to at least one of: (1) enhance, promote or enable, directly or indirectly, the formation and/or transport of the species, reactant, fragment or byproduct which is at least ultimately transportable out of a brain or spine region and into a CSF space, lumen, cavity or bloodstream, (2) enhance the transport or mixing of the species within CSF and/or blood or across tissues or existing barriers and membranes, and (3) enhance or promote the increased production of fresh CSF or blood;
(c) said at least one of enhanced formation, transport, mixing or production contributing at least ultimately to some removal of said species from the body and/or at least some immediate or later reduction in concentration of said species in a portion of the body at least in part by using one or more natural paths, emitter-enhanced paths, drug-enhanced paths, surgical or artificial shunting means, port means, or internal or external dialysis or filtering means, thereby at least slowing or stopping a disease process; and
(d) said patient optionally receiving a drug before, during or after an operation of the emitter(s) to at least one of: (1) act or help act against a disease proccess or a contributing factor thereto, (2) promote the formation or transport of a species that is to be removed or is more easily removable than a natural species, (3) encourage or enable growth or regrowth of new or transplanted brain or stem cells or enhance functional brain or neural pathways, (4) encourage or enable the beneficial uptake, processing or interaction of a genetic medicament, and (5) minimize potential or expected side-effects of an emitter exposure or shunting or port procedure., at least one such drug acting at least one of independently of, in cooperation with, or synergistically with an acoustic exposure.

2. The apparatus of claim 1 wherein the apparatus accelerates or enables diffusional, perfusive or other mass-transport of species across a brain/CSF interface, brain/blood interface, CSF/blood interface, membrane, interface or blood-brain-barrier in any direction.

3. The apparatus of claim 1 wherein the apparatus accelerates diffusional, perfusive or mass-transport of species or of CSF or of any CSF-contained species across the arachnoid villi or arachnoid membrane in any direction.

4. The apparatus of claim 1 wherein the apparatus provides acoustically driven stirring, streaming, perfusion or flow of blood in a blood flowpath/lumen or of CSF in a CSF cavity or lumen, the enhanced or initiated flow contributing to mass transport of a species in a direction useful for its natural or artificial removal from the body.

5. The apparatus of claim 1 wherein the apparatus operates in cooperation with or in support of a shunt, a port, a filtration or dialysis means, or any means used to controllably extract or cleanse CSF or blood of a species having relevance to a neurodegenerative disease process

6. The apparatus of claim 1 wherein the apparatus operates in at least one of the following manners:
(a) it provides or encourages, at least in part, at least some increased production of fresh or new CSF;
(b) it allows for the use of a port rather than a shunt;
(c) it allows for the shorter-period deployment of a shunt or port or the entire avoidance thereof,
(d) it allows for a shunt or port to remove CSF or undesired species more quickly or more safely such as at a lower flow rate or at a more benign pressure;
(e) it enhances the body's own removal rate for an undesired species at least temporarily;
(f) it allows for the avoidance of the use of at least one of a shunt or port;
(g) it provides ultrasound-assisted drug therapy supportive of the slowing or stopping of a neurodegenerative disease;
(h) it treats Alzheimer's Disease or factors thought to lead thereto;
(i) it increases transport of an undesired species or a species involved in a neurodegenerative disease process into the bloodstream or into CSF; and
(j) it interferes with a disease pathway, whether physical, chemical, biological or genetic.

7. The apparatus of claim 1 wherein said emitter means is located outside the body of said patient.

8. The apparatus of claim 7 wherein at least one emitter is located outside the skull of said patient.

9. The apparatus of claim 8 wherein therapeutic acoustic or vibratory energy is directed or passed through or across at least a portion of the patient's blood-brain barrier, arachnoid-villi, arachnoid membrane or skull bone.

10. The apparatus of claim 9 wherein at least some of said therapeutic acoustic or vibratory energy opens at least a portion of said blood-brain barrier, arachnoid-villi or arachnoid membrane, at least temporarily, for enhanced passage at least one of inwards or outwards, of medicaments, drugs, byproducts of the deposition therapy process itself or of a disease species.

11. The apparatus of claim 9 wherein said therapeutic acoustic or vibratory energy is at least one of: (a) below the unaided cavitation threshold and therefore blood brain barrier opening via unaided cavitation mechanisms is largely avoided, (b) above the unaided cavitation threshold and therefore cavitation significantly aids the opening of the blood brain barrier, (c) above a reduced energy level required to cavitate or excite an administered microbubble, microparticulate or other cavitation or excitation agent such that its vibrational motions significantly aids opening of the blood brain barrier, and (d) sufficient to enable or enhance transport of blood or a disease species across the arachnoid villi.

12. The apparatus of claim 1 wherein at least one emitter is located inside the body of said patient.

13. The apparatus of claim 12 wherein at least one emitter is located inside a skull boundary or skull of said patient.

14. The apparatus of claim 13 wherein at least one emitter is located in a natural neurological lumen, cavity or passage adjacent to or within the brain or neurological system and said emitter is capable of emitting or directing therapeutic energy into a surrounding, adjacent or nearby brain or neurological region.

15. The apparatus of claim 13 wherein at least one emitter is located in or delivered into said skull via access through a craniotomy, other skull borehole or opening, via any natural body lumen, through the vascular system or through a natural interior space or cavity.

16. The apparatus of claim 1 wherein at least one emitter is operated at least a portion of the time with at least one operating characteristic selected from the group consisting of continuous wave operation (CW), pulsed wave operation (PW), single-pulse operation, shaped-pulse operation, multipulse operation, pulse-train operation, broadband operation, narrowband operation, chirped operation, multitone operation, multifrequency operation, having a harmonic frequency, having a pre-determined waveform, having controlled duty-cycle operation, having a predetermined frequency component or spectrum, having a fundamental or primary frequency, having a variable frequency, having a predetermined constant or variable amplitude, emitting a compressive and/or rarefaction wave, emitting a shear wave, or having a frequency useful for manipulating a microbubble, microparticle or contrast agent.

17. The apparatus of claim 16 wherein output from at least one emitter is at least one of focused, collimated, weakly focused, unfocused, diffused, diffuse, defocused, beamformed, steered or wiggled in any manner.

18. The apparatus of claim 17 wherein formation of said output from at least one emitter employs electronic phase-delays applied across subelements within one or more individual emitters or across different emitters such electronic beam-steering or beam-forming takes place.

19. The apparatus of claim 17 wherein formation of said output from at least one emitter employs mechanical shaping of an acoustic component of one or more individual emitters such that at least one said emitter utilizes a mechanically-shaped acoustic component for shaping acoustic emission from at least that emitter.

20. The apparatus of claim 1 wherein multiple acoustic or vibration emitters are employed, at least some of said emitters temporally capable of at least one of individual, simultaneous, sequential, interleaved, overlapping, and phase-delayed operation relative to at least one other emitter.

21. The apparatus of claim 20 wherein at least some emitters are arranged in at least one of the following manners:
(a) at least one of said emitters is one of mechanically defocused, mechanically collimated, mechanically weakly focused, mechanically focused, or mechanically diffused or diffuse and said multiple emitters together allow for greater total brain-volume coverage or skull-area coverage than that offered by a single said emitter;
(b) the arrangement of (a) but wherein electronic phase-delay firing between at least two said emitters is also used for purposes of beam forming, steering, slewing or wiggling of emissions;
(c) the arrangement of (a) or (b) wherein phase delays are applied within at least one said emitter possessing at least two subelements such that at least one said emitter can internally provide some beam manipulation or slewing;
(d) at least one said emitter is mounted in or to a receptacle, hole or locating mechanism in or on a headpiece designed to hold or position at least one emitter;
(e) at least one said emitter can be attached to, mounted upon or located by said patient's headpiece in more than one possible position or angle relative to the skull;
(f) at least one said emitter is mounted in, on or located by said patient's headpiece in response to known brain or neural therapy target positions as determined by a brain or neural image;
(g) at least one said emitter is acoustically coupled into a patient's brain or neurological region, with or without the aid of a headpiece or other emitter housing or locating means; and
(h) at least one said emitter is acoustically coupled into the skull or a therapy target region using an intermediate acoustically conductive film, gel, paste, cream or liquid.

22. The apparatus of claim 1 wherein at least one emitter incorporates, is thermally coupled to, or is thermally managed or monitored by a cooling means, temperature control means or temperature monitoring means which controls or monitors the temperature of at least one of (a) at least one emitter, (b) any portion of a patient's anatomy, (c) the temperature or flow of a coolant, and (d) the temperature of an acoustic couplant material juxtaposed to an emitter.

23. The apparatus of claim 22 wherein at least one temperature of at least one portion of said patient's anatomy is monitored, deduced or projected and utilized in controlling, limiting, adjusting or setting a power delivery parameter of said system, manually or automatically.

24. The apparatus of claim 1 wherein at least one emitter is located inside the patient's skull, the emitter capable of emitting acoustic or vibration therapy energy into at least one selected adjacent or affected brain or neurological region, said emitter being at least one of: (a) an emitter which emits a fixed beam relative to itself, (b) an emitter which emits an electronically steerable beam, steerable relative to itself, (c) an emitter which can have its beam mechanically steered or moved via physical movement of the emitter itself or of an interior portion thereof, and (d) an emitter which emits a focused, weakly focused, collimated, defocused, unfocused diffused or diffuse emission pattern.

25. The apparatus of claim 1 wherein the system is sufficiently portable that it may be operated in at least one of: (a) at a patient's home, (b) at a clinic, (c) at a nursing home, (d) at a doctor's office, (e) at an out-patient facility, (f) next to a chair or bed in which the patient resides, (g) at a chosen hospital bedside, and (h) in a manner allowing the patient to view or hear music, television or video content and thus be simultaneously entertained.

26. The apparatus of claim 1 wherein at least one brain or neurological region is chosen for a therapy exposure or session, or such an exposure or session is designed, planned or monitored with the help of at least one of the following:
(a) at least one radiological, diagnostic or functional image or graphic representation of said patient's brain, brain function, metabolism, neurology or neurological function or disease state;
(b) at least one statistical model or database based on a relevant patient or human population;
(c) at least one lab-test or clinical test performed on said patient or on at least one patient's lab specimen, invasively or noninvasively; and
(d) at least one incidence of at least one of the above choosing, designing or monitoring methods taking place at least once before, during or after a therapy.

27. The apparatus of claim 26 wherein said image or graphical representation is obtained using at least one of: positron-emission tomography (PET), single photon emission computed tomography (SPECT), functional positron emission tomography (fPET), magnetic resonance imaging (MRI), functional magnetic resonance imaging (fMRI), computed tomography (CT), computer aided tomography (CAT), X-Ray imaging, fluoroscopy, and ultrasound imaging (US) or using a spectroscopy technique based on one or more of these tools.

28. The apparatus of claim 26 wherein said statistical model or database is one based on at least one of: (a) a database including living or deceased patients, (b) a database including genetic tendencies to acquire said disease or of genetic test results, (c) a database including risk factors for said disease, (d) a database including lab-test or clinical-test results, (e) a database including data from said patient, (f) one or more radiological, diagnostic or functional image of at least one patient, and (g) any patient record or report.

29. The apparatus of claim 1 wherein a parameter of a given therapy session or a number of or parameter of further sessions to be undergone is determined, at least in part, by the use of at least one lab-test or by a radiological, diagnostic or functional image or graphical representation which provides information relating to the current state, a recent state or an anticipated state of said disease in said patient.

30. The apparatus of claim 29 wherein at least one said lab-test involves the taking or observing of a sample or portion of bodily fluid or bodily tissue and said sample is either non-invasively observed or is physically taken from the patient at least once, at least temporarily, before, during or after a therapy.

31. The apparatus of claim 29 wherein at least one said lab-test involves the observation, recording or measurement of a property or state of the patient's spinal fluid, blood, urine, skin, tissues, other bodily fluid or physiological parameter and said lab-test is performed on said patient or on patient's sample at least once before, during or after a therapy invasively or noninvasively.

32. The apparatus of claim 1 wherein an abnormal protein-related or prion-related disease affecting or expected to potentially affect the patient's brain or neurological system, directly or indirectly, is diagnosed to possibly, likely or certainly be one or more of: Guam-Parkinsonism dementia complex, Dementia Pugilistica, Parkinson's Disease, adult Down Syndrome, Subacute Sclerosing Panencephalitis, Pick's Disease, Corticobasal Degeneration, Progressive Supranuclear Palsy, Amyotrophic Lateral Sclerosis/Parkinsonism Dementia Complex, Hallervorden-Spatz Disease, Neurovisceral Lipid Storage Disease, Mediterranean Fever, Muckle-Wells Syndrome, Idiopathetic Myeloma, Amyloid Polyneuropathy, Amyloid Cardiomyopathy, Systemic Senile Amyloidosis, Hereditary Cerebral Hemorrhage with Amyloidosis, Alzheimer's Disease, Scrapie, Creutzfeldt-Jacob Disease, Fatal Familial Insomnia, Kuru, Gerstamnn-Straussler-Scheinker Syndrome, Medullary Carcinoma of the Thyroid, Isolated Atrial Amyloid, Beta2-Microglobulin, Amyloid in dialysis patients, Inclusion Body Myositis, Beta2-Amyloid deposits in muscle wasting disease, Islets of Langerhans Diabetes Type2 Insulinoma or the Polyglutamine diseases including Huntington's Disease, Kennedy's Disease, and all forms of Spinocerebellar Ataxia involving extended polyglutamine tracts.

33. The apparatus of claim 32 wherein the disease is a form of Alzheimer's Disease and at least one type of or quantity of undesired plaque or deposit is being formed or is expected to form.

34. The apparatus of claim 33 wherein a targeted plaque or plaque-forming process is related to at least one of senile plaque and fibril plaque formation contributing to a current or anticipated form of Alzheimer's disease.

35. The apparatus of claim 1 wherein at least one of a drug, medicament, vitamin, mineral or controlled dietary matter or content is either (a) utilized in support of or in cooperation with at least one plaque or prion related breakup-process, formation-interference process, or disease recovery process such that the total overall therapy delivered over one or more therapy sessions incorporates the use of said drug, medicament, vitamin, mineral or dietary matter or content and the use of said acoustic or vibratory exposure therapy, with the drug, medicament, vitamin, mineral or controlled dietary matter or content and said acoustics or vibrations being used simultaneously, sequentially or both, or (b) employed, at least in part, to ameliorate the side effects of any acoustic or vibratory exposure itself, or (c) an anti-inflammatory.

36. The apparatus of claim 35 wherein said at least one acoustic or vibratory therapy exposure, directly or indirectly, at least one of enhances, enables, accelerates, initiates or extends the action of said drug, medicament, vitamin, mineral or controlled dietary content in terms of treatment rate or completeness of the extent of treatment benefit.

37. The apparatus of claim 36 wherein said enablement, enhancement, initiation, extension or acceleration is at least one of: (a) caused by the action of said acoustic or vibratory energy upon said at least one drug, medicament, vitamin, mineral or ingested controlled dietary matter or content and (b) caused by the action of said acoustic or vibratory energy on the anatomy, body tissue or body fluids of said patient, thereby favorably preparing said anatomy, tissue or body fluid for subsequent and/or simultaneous exposure to said at least one drug, medicament, vitamin, mineral or controlled dietary matter or content.

38. The apparatus of claim 35 wherein said at least one drug, medicament, vitamin, mineral or controlled diet provides anti-inflammatory or anti-ischemic benefit.

39. The apparatus of claim 35 wherein said at least one drug, medicament, vitamin, mineral or ingested dietary content, at least in part, reaches a brain or neurological region by passing through the blood-brain barrier (BBB), arachnoid membrane or arachnoid-villi, either unaided or in aided form, wherein said aid comprises one of:
(a) the use of said at least one form of a drug, medicament, vitamin, mineral or controlled dietary ingested content known to chemically open said BBB, membrane or villi to itself or to the ingress of another therapeutic drug;
(b) the use of said acoustic or vibratory energy to open said BBB, membrane or villi via cavitation, bubble oscillation, heating or any other mechanisms;
(c) the use of said acoustic energy to drive, transport or diffuse said at least one drug, vitamin, mineral or controlled dietary ingested content through said BBB, membrane or villi without cavitation mechanisms predominating said driving;
(d) the use of a combination of said at least one drug, vitamin, mineral or controlled dietary content opening said BBB, membrane or villi and also itself delivering therapy to said brain or neurological regions of interest; and
(e) the use of at least one drug, medicament, vitamin, mineral, ingested dietary content, acoustic energy or exposure or vibrational energy or exposure to either improve the flow of a CSF constituent into the blood or to open at least portions of the arachnoid-villi.

40. The apparatus of claim 35 wherein the acoustic or vibratory exposure of at least some brain or neurological tissues accelerates or enables, directly or indirectly, the perfusion, diffusion, transport, or physical, chemical or biological therapeutic action of said at least one said drug, medicament, vitamin, mineral or controlled ingested dietary matter or of a reactive species or product thereof.

41. The apparatus of claim 35 wherein acoustic streaming, acoustic radiation-pressure or acoustic-cavitation developed in or near said brain or neurological region by said acoustic or vibratory exposure assists in transport, perfusion, diffusion, disbursement, delivery or distribution of said at least one drug, medicament, vitamin, mineral or controlled dietary ingested matter or of a subspecies, constituent or by-product thereof.

42. The apparatus of claim 35 wherein at least one drug, medicament, vitamin, mineral or controlled dietary matter comprises or includes at least a microbubble or microparticulate agent administered or ingested into the body, into the blood, into a tissue or bodily fluid or into a brain or neurological region, said agent providing for enhanced or reduced power-threshold cavitation or bubble oscillation when under acoustic or vibratory illumination, said enhanced cavitation or oscillation at least micromechanically and therapeutically contributing to at least one of a plaque breakup, formation-interference, or disease-aiding therapy process.

43. The apparatus of claim 42 wherein said microbubble or microparticulate also acts as a drug or medicament carrier or drug-bearing medium, at least one therapeutic drug or medicament emanating from said microbubbles or microparticles at some point after administration or ingestion into the body of said patient, said emanation taking place by natural leakage, diffusion or release of drug from said microparticles or by acoustically excited release, diffusion or leakage from said particulates.

44. The apparatus of claim 35 wherein at least one drug, medicament, vitamin, mineral or controlled dietary matter supporting the therapy, directly or indirectly, includes at least one of: 4-hydroxynonenal, acetylcholinesterase or acetylcholine modulators, 1-amino-3,5-dimethyladamantane hydrochloride, acetyl-1-carnitine, alpha 2-macroglobulin drugs, alpha-synuclein or synuclein modifiers or modulators, antibodies, anti-coagulants, anti-inflammatories, anti-ischemics, anti-oxidants, anti-sense drugs, apolipoprotein or apolipoprotein-gene modifiers or modulators, apomorphine-based molecules, donepezil, aspirin, beta-secretase modifiers or modulators, biological reducing agents, celecoxib, 5-aminosalicyclic acid, chelation modulators or agents, cholesterol modulators, cholinergic drugs, coenzyme Q10, tacrine-hydrochloride, cognition-enhancing drugs, cyclooxygenase-2 (COX-2) inhibitors, C-terminal tau inhibitors, diets controlling calories or fat, diets providing anti-oxidants, diets providing vitamins or minerals, domain ligands, donepezil, diazespam, drugs which affect protein kinase C pathways or tyrosine kinase pathways or phosphotyrosine pathways, drugs which affect copper or zinc binding to clioquinol, drugs which modulate aluminum, zinc, copper, iron, fluoride or calcium species, estrogen, drugs which affect APP protein or mutant APP, drugs which affect any one of APOE or APOEe4 or any APOE allele, drugs which affect presenilin protein or presenilin 1, drugs which affect a proteolysis function, drugs which affect tau genes or tau mutations, drugs which affect the behavior of chromosome 17, drugs which reduce oxidative damage, drugs which reduce oxidative damage to RNA, drugs which reduce free radicals, estrogen-like drugs or estrogen-like replacement therapies (ERTs), drugs which treat the cholinergic system, rivastigmine tartrate, folate or folic acid modulators, galantamine, gamma-secretase drugs, gene delivery drugs, genetically engineered drugs, Ginkgo Biloba, glutamate modulators, homocysteine modulators, hormones, Hydrochloride, hyperzine A, H₂O₂ modulators, ibuprofen, immunomodulating drugs, indomethacin, inflammatory cytokines, insulin degrading enzyme IDE, iron modulators or modifiers, ketone drugs, kinesin-1 modulators, leteprinim potassium, lithium, M-CSF or macrophage colony stimulating factor, memantine, mimetics, monoclonal antibodies, matrix metalloproteinase (MMP) modulators, leteprinim-potassium, neurotrophic factors, neural growth factors (NGFs), notch protein drugs, non-steroidal anti-inflammatories (NSAIDS), nitric oxide modulators, parkin gene modulators or modifiers, peptides, plasmins, PP1 enzyme blockers, prednisone, prodrugs, protease inhibitor gene drugs, protein-kinases, proteolytic antibodies, R-flurbiprofen, galantamine HBr, rivastigmine, serum nerve growth factor, rofecoxib, statins, stem-cells or stem-cell derived medicaments, steroids, tacrine, transplanted cells, transplanted cell constituents, transplanted genetic materials, transplanted body fluids or fluid constituents, triterpenoids, ubiquitin-C-hydrolase-L1, vaccines, rofecoxib, vitamins, Vitamin C, and Vitamin E, beta-amyloid modifiers or modulators, tau modifiers or modulators, vaccines, PYM50228, gamma-aminobutyric acid (GABA), GABA-like drugs, muscimol, benzodiazepines, Wnt, beta-catenin, HoxB4, and tal-saclidine.

45. The apparatus of claim 35 wherein the patient at least one of is administered, ingests or takes a drug, medicament or controlled dietary matter before, during or after at least one acoustic or vibratory exposure, the drug or medicament reaching a tissue to be treated, directly or indirectly, before, during or after an exposure to said acoustic or vibratory energy.

46. The apparatus of claim 1 wherein at least one drug, medicament, vitamin, mineral or controlled dietary matter or content is used for at least one of: (a) to provide, enable, initiate, extend or accelerate at least one plaque, protein or prion breakup process, formation-interference process, or disease recovery process and (b) to ameliorate a side-effect of said acoustic or vibratory exposure, and said at least one drug, medicament, vitamin, mineral or controlled dietary matter or content is administered, ingested, taken-in, therapeutically delivered, provided, prescribed or recommended to said patient.

47. The apparatus of claim 46 wherein said administration or intake is via (a) oral ingestion by eating or drinking, (b) nasal or oral inhalation, (c) injection or introduction anywhere into the body of said patient, either percutaneously, transdermally or via a natural orifice (d) metered or controlled release from outside or inside the body of said patient, (e) via a skin-patch, (f) via a catheter or port, or (g) via the delivery of genetic or cellular materials from outside the body.

48. The apparatus of claim 46 wherein said administration, provision or intake is via metering or controlled release from a pump, injector or other flow, flow-direction, or pressure-controlled source located anywhere outside or inside the body of said patient.

49. The apparatus of claim 1 wherein said acoustic or vibratory exposure provides, initiates, extends, enables or accelerates to a useful degree the rate or extent of at least one said breakup, interference or aiding process via mainly acoustic-driven mechanisms without the required use of medicaments, vitamins, minerals or controlled dietary ingested matter for said providing, enabling or acceleration.

50. The apparatus of claim 1 wherein at least one said acoustic or vibratory exposure is arranged or chosen to utilize at least one acoustic or vibratory wavelength which bears a calculatable or histological relationship to a characteristic dimension of a plaque, fibril or prion-related deposit or defect, said choosing causing a desirable mechanical interaction between said plaque, fibril, nodule or defect and said acoustic or vibratory waves, thereby micromechanically contributing to at least one of said breakup, interference, and aiding processes.

51. The apparatus of claim 50 wherein said characteristic dimension is approximately that of a representative plaque, prion, protein, fibril, nodule, defect or deposit dimension.

52. The apparatus of claim 1 wherein a cooling or heat-exchange means is provided which is in thermal communication with at least one of: (a) an emitter, (b) any of the anatomy of said patient, and (c) the skull of said patient, and heat flows directly or indirectly either to or from said cooling or heat-exchange means to or from at least one of an emitter, a patient's anatomy or a patient's skull.

53. The apparatus of claim 52 wherein the cooling or heat-exchange means provides for: (a) controlling or limiting the temperature of said at least one emitter, directly or indirectly, (b) controlling or limiting the temperature of at least a portion of said patient's anatomy or of the skull of said patient, directly or indirectly, or (c) the use of higher acoustic powers than would otherwise be possible without use of said cooling or heat-exchange means, while maintaining safe maximum patient temperatures.

54. The apparatus of claim 1 further including at least one of: (a) a cooling or heat-exchange means for transferring heat to or from at least one emitter, from a portion of the patient's anatomy, or from the skull of said patient and the operation of an included cooling or heat-exchange means is in response or in support of the operation of at least one emitter or to temperatures caused thereby in the skull or anatomy, and (b) a drug, medicament, vitamin or mineral delivery means providing a drug, medicament, vitamin or mineral in support of at least one plaque, protein or prion breakup process, formation-interference process, or disease therapy processes, said drug, medicament, vitamin or mineral delivered to said patient responsive to at least one of a flow control, a pressure control, a dosage control, a blood-concentration control, a sensor, a software or firmware program, a system control setting, a sensor, a timer, a real-time or individual-use lab-test or test-sampling, and a practitioner's direction.

55. The apparatus of claim 1 wherein at least one emitter's output is mechanically scanned relative to said patient's brain, either by patient movement, system movement, emitter movement or emitter relocation on the headgear or a combination thereof.

56. The apparatus of claim 1 further including a removable helmet, head-band or other juxtaposed or head-attached structure for securement to or juxtaposition to the head of said patient, said helmet or structure incorporating or providing mounting, locating or positioning means for at least one said emitter, said helmet/structure or emitter(s) therein or thereon becoming acoustically coupled to the patient, said coupling being achieved into or through the patient's scalp or skull thereby allowing delivery of acoustics into the patient.

57. The apparatus of claim 56 wherein the patient's head is at least partially in, enclosed by or surrounded by a helmet, head-band or head-attachment structure containing, supporting, locating or positioning at least one emitter, said structure being at least partially supported by said apparatus yet also being mounted to or at least placed near or on the patient's head in order to perform said therapy.

58. The apparatus of claim 56 wherein the patient's head is in a helmet, head-band or head-attachment structure containing or having attached thereto or thereon at least one emitter, said structure having one or more of an umbilical, cable or coolant lumen which connects or is connectable to said system.

59. The apparatus of claim 1 further including acoustic coupling means for coupling output from at least one emitter directly or indirectly into a tissue or body fluid of said brain or neurological system, said acoustic coupling means utilizing at least one of (a) an interposed liquid, gel, paste, cream, emulsion or acoustic-standoff, (b) an interposed inflatable fillable or soakable bag, membrane or sponge material, (c) an interposed acoustically water-like material.

60. The apparatus of claim 59 wherein said acoustic coupling means also provides some skull size or shape adaptability for various-sized or shaped patient's heads for a given patient or from patient to patient.

61. The apparatus of claim 1 wherein operational set-up or compensation is made for at least one of the following variables or changes: (a) variable skull thickness or shape from location to location on a given skull, or variable skull thickness or shape from patient-to-patient, (b) a variable skull, scalp or emitter temperature from location to location or at a single location over time, (c) a change in a relevant or representative brain or neurological temperature, (d) a change in a local or a nearby temperature in a general region of diseased or treated brain or neurological tissue, (e) a change in the result of an invasive or noninvasive lab-test monitoring a variable related to a state of the disease or to a state of a plaque-burden, (f) a change in a metabolic or physiological instrument reading or patient-monitor, (g) a change in the patient's comfort level, (h) a change or variation in the acoustic velocity, attenuation or dimension of a patient's skull, skin, brain or neurological tissue or plaque, (i) a change or variation in detected brain-tissue perfusion or in cerebral lumen blood-flow, a change in the cavitation or oscillation behavior of a microbubble or microparticulate, (k) a change in an actual or desired concentration or of a delivery parameter of a drug, (1) a change in an actual or desired acoustic power to be delivered, (m) a change in the actual or desired concentration of a species of interest in a blood, urine, skin or spinal fluid test or ongoing sampling, and (n) a change in a brain radiological or functional image or graphical representation, (o) a change in the amount of, nature of or presence of undesired side-effects being experienced or detected or anticipated, (p) a change in blood pressure or cerebrospinal fluid pressure, (q) a change in a state of inflammation whether due to the disease or the acoustics themselves, (r) a change in any brain function, (s) changes in locations or concentrations of plaque, fibrils or nodules within a single patient over time or from patient to patient, and (t) direction provided by software, firmware or by an operator or overseer of the system, regardless of whether any one of these is locally or remotely located.

62. The apparatus of claim 1 wherein acoustic or vibratory energy is also utilized to diagnostically probe or measure a characteristic of the brain, skull, neurological system, disease state, physiology or temperature of said patient or operation of an emitter, the characteristic useful to set up, control or insure safe or efficient operation of said system.

63. The apparatus of claim 1 wherein said at least one acoustic or vibratory emitter comprises an ultrasonic, acoustic or vibratory element which is electrically, electrostatically, magnetically, magnetostrictively, electromagnetically or optically driven or wherein said emitter is an acoustic output port coupled to an acoustic waveguide.

64. The apparatus of claim 1 wherein said at least one acoustic or vibration emitter is coupled, directly or indirectly, into said patient's brain or neurological system through at least one of an upper or lower jaw, neck or spine of said patient.

65. The apparatus of claim 1 wherein said acoustic or vibratory coupling means includes:
(a) a shaved head or a head with reduced hair quantity;
(b) wetted hair using any hair-wetting material or a wetted scalp using any scalp-wetting material;
(c) wetted or gel-coated emitter or emitter portions;
(d) inflated or filled expandable acoustically-conductive bags, membranes or standoffs;
(e) provision of a saturatable or soakable material which acts as an acoustically transparent standoff or coupler in the soaked state;
(f) provision of a flexible or stretchable acoustically-transparent skull-cap which is wettable or which promotes acoustically coupling on at least one inner or outer surface;
(g) provision of a flexible or stretchable skullcap which serves to control the patient's hair;
(h) flow or placement of an acoustically conductive liquid in an emitter/skull interface region;
(i) flow or placement of an acoustically conductive coolant or other heat transfer media in an emitter/skull interface region; and
(j) flow or placement of an acoustically conductive gel or paste in an emitter/skull interface region.

66. The apparatus of claim 1 wherein at least a portion of one plaque, protein or prion containing deposit, nodule or body undergoes at least one of shear, compressional or tensile-distortion or stress or is excited into a vibratory mode by an acoustic or vibratory emission having a wavelength chosen to bear a relationship to a characteristic dimension of at least one said deposit, nodule or body, the distortion, stress or vibratory behavior favorably contributing to at least one of said therapeutic breakup, interference, and aiding process.

67. The apparatus of claim 1 wherein at least one plaque, protein or prion-containing deposit, nodule or body is or are, at least in part, one of spatially distributed, diffusely distributed, aggregated, agglomerated, intracellularly situated, extracellularly situated, fibril-like, plaque-like, have a microscopic sheet structure or are directly or indirectly associated with cognitive losses.

68. The apparatus of claim 1 wherein the acoustic or vibrational excitations in combination with an optional drug provide a disease-therapy process in order to ultimately achieve at least one of: (a) enhanced perfusion, diffusion, transport or distribution of blood or cerebrospinal fluid or fluid constituents including disease species, (b) enhanced perfusion, diffusion, transport or distribution of a drug or medicament, (c) enhanced perfusion, diffusion, transport or distribution of a functional signaling chemical or species, (d) enhanced cognitive function, (e) enhanced transport of a plaque, prion or deposit breakdown product or related debris, (f) enhanced perfusion, diffusion, transport or distribution of a medicament incorporating stem cells, living cells, or byproducts or derivatives of cells, whether natural cells or genetically manipulated cells, and (g) delivery or distribution of dead or living cells or cell constituents or derivatives serving as a vaccine.

69. The apparatus of claim 1 wherein at least one of: (a) said acoustic or vibratory exposure contributes to enhanced cognitive function or a decrease in the rate of cognitive loss, and (b) said acoustic or vibratory exposure combined with the sequential or simultaneous use of a drug, medicament or controlled dietary intake both contribute in at least some manner to enhanced cognitive function or a decrease in the rate of cognitive loss, regardless of whether said acoustic or vibratory energy provides, enables or accelerates the action of the drug, medicament or dietary content.

70. The apparatus of claim 69 wherein said acoustic or vibratory energy provides, enables, accelerates or initiates a beneficial action of at least one said drug, medicament or dietary content, either directly or indirectly.

71. The apparatus of claim 1 wherein it causes the concentration or activity of a chemical, genetic, cellular or biological material, reactant, product or byproduct which plays a damaging role or is involved in the damage sequence or chain of events of the neurodegenerative disease to be at least partly reduced, partly inactivated, chemically tied up or rendered inactive such that the rate of neural damage is slowed or stopped.

72. The apparatus of claim 71 wherein said activity or concentration is reduced, tied up or made inactive accompanied by its ultimate removal from the body with the help of a natural body process, possibly acoustically enhanced, including at least one of: (a) brain metabolism, (b) brain perfusion or circulation of blood, (c) cerebrospinal fluid production or circulation, and (d) body excretion as waste.

73. The apparatus of claim 72 wherein said acoustic or vibratory exposure facilitates or accelerates said subsequent removal in any manner.

74. The apparatus of claim 1 wherein the patient at least one of:
(a) receives an initial lab-test, imaging session, diagnostic session or other exam or test in order to stage the disease or to understand the disease potential;
(b) receives a plaque, protein or prion material-breakup, formation-interference or disease-aiding therapy over a period of one or more sessions;
(c) receives a combination of at least two of breakup, interference or aiding therapies over a period of one or more sessions;
(d) receives at least one each of said breakup, interference, and aiding therapy in at least one session;
(e) receives at least one each of said breakup, interference, and aiding therapy over a period of two or more sessions;
(f) has a body fluid or tissue sample taken before, during or after at least one therapy session;
(g) has a body fluid or tissue analyzed or monitored invasively or non-invasively, before, during or after at least one therapy session; and
(h) undergoes functional imaging or cognitive testing.

75. The apparatus of claim 1 wherein cooling or heat-exchange is employed to maintain, limit or control a temperature related to the patient's anatomy or to the therapy delivery means, regardless of whether the system is aware of the actual temperature present or temperature being controlled.

76. The apparatus of claim 1 wherein a wired, wireless, digital, analog, telephony, data, fiberoptic, video or network connection allows for interaction with the therapy apparatus or patient from a distance or from a remote location.

77. The apparatus of claim 1 wherein: (a) multiple emitters are employed, each primarily treating at least some unique emitter-assigned brain or neurological system region or subregion, (b) multiple emitters are employed and there is a significant over-lap in the treated or treatable regions or subregions addressable by said emitters, (c) multiple emitters are employed in any manner and operated sequentially, (d) multiple emitters are employed in any manner and operated simultaneously, (e) multiple emitters are employed in any manner and at least two are operated with controlled phase angle delays relative to each other, (f) at least one emitter comprises multiple acoustic subelements, (g) at least one emitter steers or shapes emissions, at least in part, using a mechanically shaped acoustic component, (h) at least one emitter is moved among at least two different possible mountable positions or angles over a period of one or more therapies, (i) at least one emitter mates with electrical or coolant connectors predisposed in the helmet or headgear, (j) at least one emitter structure also serves to form the structure of the helmet itself, (k) the helmet or headgear or emitter housing or holder is, at least in part, directly made from material which is capable of emitting or receiving acoustic energy, (l) the helmet or headgear is mechanically mated to the patient during operation, (m) the patient rests or places his/her head juxtaposed against or to a pillow-like entity which holds an emitter, (n) the headgear, helmet or pillow structure holding at least one emitter also incorporates a thermal control means during operation, (o) an emitter is chosen for its frequency or penetration ability, (p) an emitter is chosen for its fit to the helmet or to the patient, (q) the patient sits, reclines or lies down during the therapy, (r) the patient is entertained with audio and/or video content during the therapy, ( s) the patient undergoes therapy using a portable or semiportable system, (t) the patient undergoes therapy at home, at a clinic, at a doctor's office, at an outpatient office, at a hospital or at a nursing home, (u) the patient intakes a drug, medicament, controlled dietary content or therapeutic genetic or cellular substance before, during or after at least one therapy session, both the emissions and the drug contributing individually or cooperatively, to therapeutic benefit, (v) comfort or adjustability is provided by an intervening acoustic standoff which is shapable, the emitters passing their emissions through said standoff, the shapability adaptable to the patient's head, (w) a shapable acoustic standoff serves as a conforming pillow for patient comfort or for improved acoustic coupling, (x) a patient acoustic coupling means incorporates a thermal control feature, or (y) an emitter itself incorporates a connector or a thermal control means.

78. The apparatus of claim 1 wherein said acoustic or vibratory exposure is of intensities or powers which allow for prolonged exposure or multiple exposures of said patient's brain or neurological system without accumulating unacceptable acoustically-induced permanent damage to neurologically significant portions of the patient's anatomy, tissues or fluids.

79. The apparatus of claim 1 wherein said acoustic or vibratory exposure is of intensities or powers such that the accumulated time at temperature of treated brain regions is below that which would cause significant permanent thermal damage to healthy cells.

80. The apparatus of claim 1 wherein the ultrasonic or vibratory power per unit area is between 5 milliwatts per square centimeter and 10 watts per square centimeter.

81. The apparatus of claim 80 wherein at least one of:
(a) at least one frequency between 1 hertz and 2 megahertz is employed with or without cooling or heat-exchange;
(b) at least one frequency of between 2 megahertz and 5 megahertz is employed with cooling or heat-exchange;
(c) the temperature rise in a portion of the patient's tissue or bodily fluid is limited to 5 degrees centigrade or less;
(d) the duty cycle of the acoustic power is set between 10 and 25% on-time; and
(e) healthy tissues are spared permanent unacceptable thermal or acoustic damage.

82. The apparatus of claim 1 wherein at least one acoustic emitter is inside the skull of said patient or in an interior location of said patient's brain or neurological system and acoustic or vibratory energy emanates in at least one direction generally outward toward a patient's scalp or toward a skinline.

83. The apparatus of claim 1 wherein any emitter energy beam-forming or beam-steering is done at least for the purpose of achieving increased or more uniform coverage of targeted or targetable brain or neurological regions.

84. The apparatus of claim 1 wherein the disease or incipient disease being treated is, at least in part, resident in any of the following brain or neurological tissues: hippocampus, entorhinal cortex, cerebral cortex, posterior cingulated cortex, neocortex, allocortical regions, basal forebrain, or cerebellar tissues.

85. The apparatus of claim 1 wherein at least some of the acoustic or vibratory energy is capable of providing, enabling, accelerating or initiating a plaque, prion or protein containing breakup-process, interference-process or disease-aiding process, the acoustic or vibratory therapy process itself not requiring a drug, medicament or controlled dietary content to proceed at a useful pace or to a useful extent.

86. The apparatus of claim 85 wherein said breakup, interference or aiding process enhances patient cognition at least after some time has passed.

87. The apparatus of claim 1 wherein a drug, medicament or controlled dietary content is used to comfort the patient or to relieve existing or potential side-effects of an acoustic or vibratory exposure, regardless of whether it contributes to the therapy itself

88. The apparatus of claim 1 wherein cognition loss is at least slowed, stopped or reversed at least after some time has passed.

89. The apparatus of claim 1 wherein the primary physical components of said apparatus include a console or control box, a headpiece incorporating at least one said emitter, and at least one connecting or connectable cable or lumen connecting said console and said headpiece.

90. The apparatus of claim 1 wherein a bodily fluid such as blood or cerebro-spinal fluid is manipulated in any manner in cooperation with at least one said acoustic or vibratory exposure or by said exposure, the combined exposure and manipulation having at least one of additive, extending or acceleration-of-therapy effects.

91. A method for the therapeutic treatment of abnormal protein-related or prion-related diseases of a human patient's brain or neurological system comprising:
(a) coupling at least one acoustic or vibratory emitter into a patient's brain or neurological system or portion thereof; and
(b) exciting said emitter to emit acoustic or vibrational energy with a desired characteristic directly or indirectly into or through said brain or neurological system or portion thereof, the emitted energy designed to provide, enable, accelerate or initiate at least one of the following therapy processes in cooperation with the optional use of a drug:
(1) physical breakup, breakdown, erosion, dispersion, disentanglement, de-aggregation, redistribution, dissolution, de-agglomeration, de-amalgamation or permeation of at least some disease-related deposits, nodules or bodies thereby improving the transport of a disease species out of the body by at least one of a shunt, a port, a natural bodily process, an energy-enhanced natural bodily process, natural or enhanced bloodflow, or by natural or enhanced CSF flow,
(2) at least temporary opening of the blood-brain-barrier (BBB) or arachnoid-villi for the purpose of enabling or improving the transport of a disease related species out of the body by any means including artificial shunt or port means and enhanced arachnoid-villi flow,
(3) acoustic or vibrational stirring or mixing of blood or cerebrospinal fluid for the purpose of enabling or improving the transport of a disease related species out of the body by any means including artificial shunt or port means or any natural bodily means,
(4) enhancing the transport of a disease-related species by enhancing or enabling CSF or bloodflow via acoustic streaming effects or by acoustic exposure causing at least temporary increases in membrane or tissue permeabilities, and
(5) drug-aided attack upon said deposits, nodules or bodies wherein the acoustic energy at least one of (i) aids in transporting the drug, (ii) activates the drug, (iii) enhances the benefit delivered by the drug, (iv) enhances the rate or extent of attack of the drug upon said deposits, nodules or bodies, and (v) has accelerated or extended benefit because of the cooperative action of the drug.

92. The method of claim 91 wherein a drug, medicament or controlled dietary content optionally being administered enhances therapy effectiveness or patient comfort, independently or in cooperation with the emitted energy.

93. The method of claim 92 wherein a drug, medicament or dietary content which is administered is at least one of: (a) known to provide useful therapy even without the acoustic emissions present, and (b) requires acoustic emissions to directly or indirectly cause the drug to be of therapeutic benefit.

94. The system of claim 92 wherein an administered drug, medicament or dietary content has its therapeutic contribution enabled, enhanced, initiated, accelerated or extended due to an effect, latent effect or side-effect of at least one acoustic exposure.

95. The method of claim 91 wherein the acoustic emissions are unfocused, weakly focused, diffused, diffuse, collimated or overlapping spatially or temporally.

96. The method of claim 91 wherein the drug also serves as an imaging contrast agent or serves to minimize an undesirable side-effect of the acoustic exposure.

97. The system of claim 91 wherein acoustic measurements or imaging is practiced in support of the therapy, regardless of whether any of the therapy emitters are also used for said measurements or imaging.

98. The method of claim 91 wherein blood or cerebrospinal fluid is otherwise manipulated in cooperation with the emission therapy, said manipulation comprising at least temporary shunting of blood or cerebrospinal fluid.

99. A method for providing therapy to a patient having, or who may potentially develop, a neurodegenerative disease characterized by abnormal proteins or prions or related deposits comprising:
(a) delivering acoustic, ultrasonic or vibratory energy in, into, through, toward, from within or coupled-into a region of the patient's brain or spine which contains, or is in transportable communication with, cerebrospinal fluid (CSF) or blood capable of bearing or bearing a chemical or biological species, reactant, fragment, by-product or species related to the disease;
(b) the emitter operable to at least one of: (1) enhancing, promoting or enabling, directly or indirectly, the formation and/or transport of the species, reactant, fragment or byproduct which is at least ultimately transportable out of a brain or spine region and into a CSF space, lumen, cavity or bloodstream, (2) enhancing the transport or mixing of the species within CSF and/or blood or across tissues or existing barriers and membranes, and (3) enhancing or promoting the increased production of fresh CSF or blood;
(c) said at least one of enhanced formation, transport, mixing or production contributing at least ultimately to some removal of said species from the body and/or at least some immediate or later reduction in concentration of said species in a portion of the body at least in part by using one or more natural paths, emitter-enhanced paths, drug-enhanced paths, surgical or artificial shunting means, port means, or internal or external dialysis or filtering means, thereby at least slowing or stopping a disease process; and
(d) said patient optionally receiving a drug before, during or after an operation of the emitter(s) to at least one of: (1) act or help act against a disease process or a contributing factor thereto, (2) promote the formation or transport of a species that is to be removed or is more easily removable than a natural species, (3) encourage or enable growth or regrowth of new or transplanted brain or stem cells or enhance functional brain or neural pathways, (4) encourage or enable the beneficial uptake, processing or interaction of a genetic medicament, and (5) minimize potential or expected side-effects of an emitter exposure or shunting or port procedure., at least one such drug acting at least one of independently of, in cooperation with, or synergistically with an acoustic exposure.

100. A method of at least temporarily slowing, stopping or avoiding a patient's cognitive losses associated with a neural deposition disease comprising administration of acoustic or vibrational energy directly or indirectly into affected or potentially affected patient anatomy portions thereby causing at least one of: (i) acoustically enhanced or enabled beneficial transport of a disease-related species into, to, through or out of a CSF or blood transport path, (ii) acoustically enhanced or enabled beneficial transport of a disease-related species into, to, through or out of a ventricle, bodily lumen, bodily organ, shunt, port or artificial fluid extraction means, (iii) acoustically enhanced or enabled beneficial transport of a disease-related species across a blood-brain-barrier (BBB), arachnoid-villi, or across any membrane or tissue, and (iv) acoustically enhanced or enabled beneficial increases in the bodily production of fresh CSF.

101. The method of claim 100 wherein at least one of the following is practiced:
(a) imaging diagnostics in support of at least one said therapy treatment;
(b) performance of a lab or clinical test upon the patient or his/her body or bodily specimens in support of at least one said therapy treatment;
(c) cognitive testing or grading in support of at least one said therapy treatment;
(d) delivery of a drug or medicament to the patient in any form, the drug acting independently or in cooperation with the acoustic or vibratory therapy;
(e) vascular delivery of an acoustic or energy emitter or energy source:
(1) through-skull or skull borehole delivery of acoustic energy or energy source,
(2) CSF or blood removal, temporary or otherwise, or
(3) CSF or blood filtering or dialysis performed in or outside of the body;
(f) at-home, out-patient, doctors office or clinical delivery of at least one therapy session; and
(g) one or more therapy sessions regardless of how many visits that requires of the patient, if any.
